(19) United States
(12) Patent Application Publication
(10) Pub. No.: US 2025/0343904 A1
(43) Pub. Date: Nov. 6, 2025

(54) ENCODING METHOD, DECODING METHOD, ENCODER, DECODER, AND STORAGE MEDIUM

(71) Applicant: GUANGDONG OPPO MOBILE TELECOMMUNICATIONS CORP., LTD., Dongguan (CN)

(72) Inventors: Yanzhuo MA, Dongguan (CN); Junyan HUO, Dongguan (CN); Fuzheng YANG, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/273,656

(22) Filed: Jul. 18, 2025

Related U.S. Application Data
(63) Continuation of application No. PCT/CN2023/073451, filed on Jan. 20, 2023.

(51) Int. Cl. H04N 19/11; H04N 19/105; H04N 19/176; H04N 19/182

(52) U.S. Cl. CPC H04N 19/11; H04N 19/105; H04N 19/176; H04N 19/182

(57) ABSTRACT

Provided are a decoding method, an encoding method, a bitstream, a decoder, an encoder and a storage medium. The decoding method includes: determining a first template corresponding to a current coding block; determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately searching the fully reconstructed search region and/or the to-be-determined reconstructed search region and determining one or more block vectors of the current coding block.

### CROSS-REFERENCE TO RELATED APPLICATIONS

This application is a continuation of International Application No. PCT/CN2023/073451, filed on Jan. 20, 2023, the disclosure of which is hereby incorporated by reference in its entirety.

### TECHNICAL FIELD

Embodiments of this application relate to the field of video coding technologies, and in particular, to an encoding method, a decoding method, a bitstream, an encoder, a decoder, and a storage medium.

### BACKGROUND

An intra template matching prediction (Intra Template Matching Prediction, Intra TMP) technology searches, according to a preset cost function, for a matching template whose cost from a template of the coding block is the smallest in a search range predefined in a current image, and uses an optimal matching reconstruction block corresponding to the matching template as a prediction block of the current coding block.

However, the search strategy does not make full use of information of reconstructed neighboring samples, and consequently, the obtained best candidate block is not the optimal candidate block, so that valid reference information is limited, and finally prediction accuracy is reduced.

### SUMMARY

Embodiments of this application provide an encoding method, a decoding method, a bitstream, an encoder, a decoder, and a storage medium, so as to improve prediction accuracy, and obtain an optimal prediction effect.

The technical solutions in the embodiments of this application may be implemented as follows:

According to a first aspect, an embodiment of this application provides a decoding method, applied to a decoder, where the method includes:
determining a first template corresponding to a current coding block;
determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and
separately searching the fully reconstructed search region and/or the to-be-determined reconstructed search region and determining one or more block vectors of the current coding block.

According to a second aspect, an embodiment of this application provides an encoding method, applied to an encoder, where the method includes:
determining a first template corresponding to a current coding block;
determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and
separately searching the fully reconstructed search region and/or the to-be-determined reconstructed search region and determining one or more block vectors of the current coding block.

According to a third aspect, an embodiment of this application provides an bitstream, where the bitstream is generated by performing bit encoding according to to-be-encode information; and the to-be-encode information includes at least one of following:
a prediction residual of a current coding block, a preset quantity N, availability information of a reference pixel, a size of a template, or indication information of a template type.

According to a fourth aspect, an embodiment of this application provides an encoder, including a first determining unit.

The first determining unit is configured to determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

According to a fifth aspect, an embodiment of this application provides an encoder, including a first memory and a first processor.

The first memory is configured to store a computer program runnable on the first processor.

The first processor is configured to execute the method according to the second aspect when running the computer program.

According to a sixth aspect, an embodiment of this application provides a decoder, including a second determining unit.

The second determining unit is configured to determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

According to a seventh aspect, an embodiment of this application provides a decoder, including a second memory and a second processor.

The second memory is configured to store a computer program runnable on the second processor.

The second processor is configured to execute the method according to the first aspect when running the computer program.

According to an eighth aspect, an embodiment of this application provides a computer readable storage medium, where the computer readable storage medium stores a computer program, and when the computer program is executed, the method according to the first aspect or the method according to the second aspect is implemented.

Embodiments of this application provide a decoding method, an encoding method, an encoder, a decoder, and a storage medium. The encoder and decoder determines a first template corresponding to a current coding block; determines a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately searches the fully reconstructed search region and/or the to-be-determined reconstructed search region and determines one or more block vectors of the current coding block.

### BRIEF DESCRIPTION OF DRAWINGS

FIG. 1 is a schematic diagram of Intra TMP prediction.

FIG. 2 is a schematic diagram of a prediction procedure based on an IntraTMP technology.

FIG. 3 is a schematic diagram of template types in an Intra TMP technology.

FIG. 4 is a schematic diagram of a search procedure based on an IntraTMP technology.

FIG. 5 is a schematic diagram of parameter definition of a current coding block and a template thereof.

FIG. 6 is a schematic diagram of a template search region.

FIG. 7 is a first schematic diagram of different sub-region division in a search region.

FIG. 8 is a first schematic diagram of a process of determining a search region.

FIG. 9 is a schematic diagram of a search process.

FIG. 10A is a schematic structural diagram of an encoder.

FIG. 10B is a schematic structural diagram of an encoder.

FIG. 11 is a schematic diagram of network architecture of a coding system.

FIG. 12 is a schematic flowchart of a decoding method according to an embodiment of this application.

FIG. 13 is a second schematic diagram of different sub-region division in a search region.

FIG. 14 is a second schematic diagram of a process of determining a search region.

FIG. 15 is a third schematic diagram of a process of determining a search region.

FIG. 16 is a fourth schematic diagram of a process of determining a search region.

FIG. 17 is a fifth schematic diagram of a process of determining a search region.

FIG. 18 is a sixth schematic diagram of a process of determining a search region.

FIG. 19 is a schematic diagram of a case in which an overlapping regin exists.

FIG. 20 is a schematic diagram of a manner of determining a predicted value in a case in which an overlapping regin exists.

FIG. 21 is a schematic diagram of implementation of repetitive padding.

FIG. 22 is a schematic flowchart of an encoding method according to an embodiment of this application.

FIG. 23 is a schematic structural diagram of an encoder.

FIG. 24 is a schematic hardware diagram of an encoder.

FIG. 25 is a schematic structural diagram of a decoder.

FIG. 26 is a schematic hardware diagram of a decoder.

FIG. 27 is a schematic structural diagram of a coding system.

### DESCRIPTION OF EMBODIMENTS

To understand features and technical content of the embodiments of this application in more detail, the following describes implementation of the embodiments of this application in detail with reference to the accompanying drawings. The accompanying drawings are merely used for description, and are not intended to limit the embodiments of this application.

Unless otherwise defined, all technical and scientific terms used in this specification have the same meaning as those commonly understood by those skilled in the art of this application. The terms used in this specification are merely intended to describe the embodiments of this application, and are not intended to limit this application.

In the following description, “some embodiments” is used to describe subsets of all possible embodiments, but it may be understood that “some embodiments” may be the same or different subsets of all possible embodiments and may be combined with each other without conflict. It should be further noted that the terms “first, second, third” in some embodiments of this application are merely used to distinguish similar objects, and does not represent a specific order of the objects. It may be understood that “first, second, third” may be interchanged if allowed, so that the embodiments described herein can be implemented in a sequence other than those shown or described herein.

Before the embodiments of this application are further described in detail, the names and terms involved in the embodiments of this application are first described. The names and terms involved in the embodiments of this application are applicable to the following explanations:
coding block (Coding Block, CB);
block matching (Block Maching, BM);
coding unit (Coding Unit, CU);
block vector (Block Vector, BV);
sum of absolute difference (Sum of Absolute Difference, SAD);
sum of absolute transformed difference (Sum of Absolute Transformed Difference, SATD);
mean square error (Mean Square Error, MSE);
sum of squared differences (Sum of Squared Differences, SSD);
mean absolute difference (Mean Absolute Deviation, MAD);
mean square differences (Mean Square Differences, MSD);
normalized correlation coefficient (Normalized Correlation Coefficient, NCC);
H.266/versatile video coding (Versatile Video Coding, VVC);
VVC test model (VVC Test Model, VTM);
intra template matching prediction (Intra Template Matching Prediction, Intra TMP);
enhanced compression model (Enhanced Compression Model, ECM).

It may be understood that, in a video image, a first color component, a second color component, and a third color component are generally used to represent the coding block. The three color components are respectively a luma component, a blue chroma component, and a red chroma component. Specifically, the luma component is generally represented by a symbol Y, the blue chroma component is generally represented by a symbol Cb or U, and the red chroma component is generally represented by a symbol Cr or V. In this way, the video image may be represented in an YCbCr format, or may be represented in a YUV format.

It may be further understood that the intra TMP is a special intra prediction mode, and both the encoder and the decoder search, according to a preset cost function, for a matching template (T_BEST) whose cost from a template (T) of the coding block is the smallest in a predefined search range of the current image, where an offset of the best matching template from the current coding block template is the best block vector (BEST Block Vector, BV_BEST), and then a reconstruction block (Ref Block) corresponding to the matching template is used as a prediction block of the current coding block (Cur Block). The template of the coding block usually uses the adjacent reconstructed region of the current coding block.

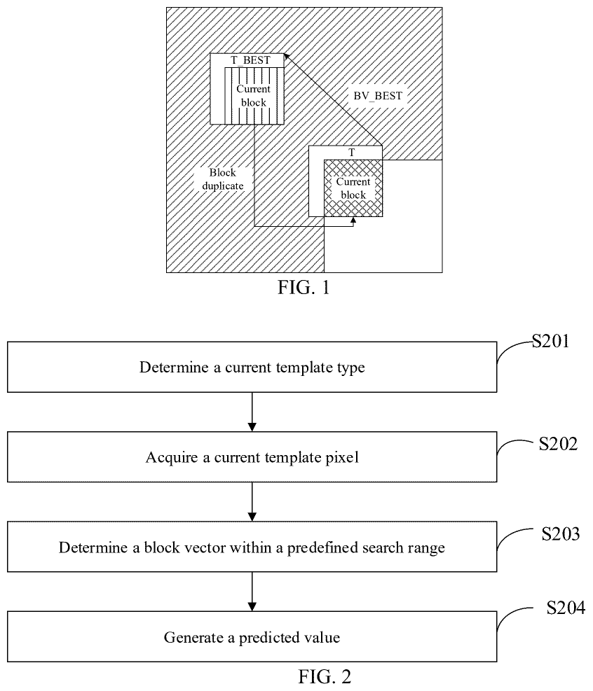

For example, a neighboring reconstructed region of the current coding block is used as an example, and FIG. 1 is a schematic diagram of prediction of the Intra TMP. As shown in FIG. 1, a dark-filled regin represents a reconstructed region, a grid-filled block is the current coding block, and an adjacent regin of the current coding block is the first template (T). A slash-filled block is a reference block, and an adjacent regin of reference block is a second template (that is, a best matching template, T_BEST). An offset of the second template relative to the first template is the best block vector (BV_BEST). In this case, the reference block may be replicated as a prediction block of the current coding block.

In some embodiments of this application, a preset cost function may be a sum of absolute difference (SAD), a sum of absolute transformed difference (SATD), a mean square error (MSE), a sum of squared differences (SSD), a mean absolute deviation (MAD), a mean square difference (MSD), a normalized correlation coefficient (NCC), or the like, which is not specifically limited herein.

For example, the sum of absolute difference (SAD) is used as an example. In this case, a cost function is shown as follows:

$$S A D ( {T}_{i} ) = {\sum }_{m = 0}^{M - 1} \vert {T}_{i , m} - {T}_{m} \vert , m = 0 , 1 , … , M - 1 \qquad ( 1 )$$

where Ti is a template in a search process, and M represents a quantity of pixels in the template.

The following describes in detail the prediction process of the Intra TMP technology in the related technologies.

Input of IntraTMP: a position (xTbCmp, yTbCmp) of the current coding block, a width nTbW of the current coding block, a height nTbH of the current coding block.

Output of IntraTMP: a predicted value predSamples[x][y] of the current coding block, where x=0 . . . nTbW−1, y=0 . . . nTbH−1.

Specifically, the prediction process of the IntraTMP technology may include four steps: determining a current template type, acquiring reconstructed pixels of a current template, determining a block vector within a predefined search range, and generating a predicted value. In this way, a predicted value of the current coding block can be obtained by the foregoing process. It should be noted that the Intra TMP technology may be used to predict the luma component, or may be used to predict the chroma component, which is not specifically limited herein.

Referring to FIG. 2, FIG. 2 shows a schematic diagram of a prediction procedure based on the IntraTMP technology. As shown in FIG. 2, the procedure may include the following steps:

S201. Determine a current template type.

It should be noted that, the Intra TMP technology searches for a matching template in a predefined search region by using neighboring reconstructed pixels of the current coding block as a template, where the neighboring reconstructed pixels may be above reference pixels, above left reference pixels, above right reference pixels, left reference pixels, below left reference pixels, or the like of the current coding block. Therefore, the templates can be classified into a corresponding template type according to availability of the neighboring reconstructed pixels.

It should be further noted that refTemplateType may be used to represent the template type. FIG. 3 shows a schematic diagram of template types of the Intra TMP technology. As shown in FIG. 3, a grid-filled block is a current coding block, and an adjacent regin of the current coding block is a template T. Six template types are shown herein.

For example, the six template types are as follows.

When above left reference pixels, above reference pixels, and left reference pixels are all available, a value of refTemplateType is 1, and a template shape is as shown in (a) in FIG. 3.

When only left reference pixels are available, the value of refTemplateType is 2, and the template shape is as shown in (b) in FIG. 3.

When only above reference pixels are available, the value of refTemplateType is 3, and the template shape is as shown in (c) in FIG. 3.

When only left reference pixels and above left reference pixels are available, the value of refTemplateType is 4, and the template shape is as shown in (d) in FIG. 3.

When only left reference pixels and below left pixels are available, the value of refTemplate Type is 5, and the template shape is shown in (e) in FIG. 3.

When only above reference pixels and above right reference pixels are available, the value of refTemplateType is 6, and the template shape is as shown in (f) in FIG. 3.

S202. Acquire a current template pixel.

It should be noted that the template of the Intra TMP technology may include reconstructed pixels on one or more of the above side, the above right side, the left side, the below left side, and the above left side of the current coding block. In addition, the template size may be preset. For example, when acquiring the template on the left side, the template width templateW_size may be set to 4. When acquiring the template on the above side, the template height templateH_size may be set to 4.

It should be further noted that reconstructed pixels may be obtained according to a value of refTemplateType. For example, when a value of refTemplateType is 1, reconstructed pixels on the left side, the above left side, and the above side of the current coding block are obtained. When a value of refTemplateType is 2, only four columns of reconstructed pixels on the left side of the current coding block are obtained. Alternatively, when the value of refTemplateType is 3, only four rows of reconstructed pixels on the above side of the current coding block are obtained.

S203. Determine a block vector within a predefined search range.

It should be noted that a search process of the Intra TMP technology mainly includes an initialization process, determining a search region of a template in a current frame, and searching and determining an optimal block vector in the search region.

It should be further noted that when searching for the best matching template in the search region, a search policy of coarse search before fine search may be used, or only fine search may be performed, or only coarse search is performed, which is not specifically limited herein.

In some embodiments of this application, the coarse search herein may specifically include: determining the best coarse matching template in the search region by using a first preset step size (for example, 2), or determining the best coarse matching template in the search region by using a downsampled template (for example, a downsampling factor is 2).

In some embodiments of this application, the fine search herein may specifically include: determining the best fine matching template in the search region by using a second preset step size (for example, 1), or determining the best fine matching template near the best coarse matching template after the coarse search is completed.

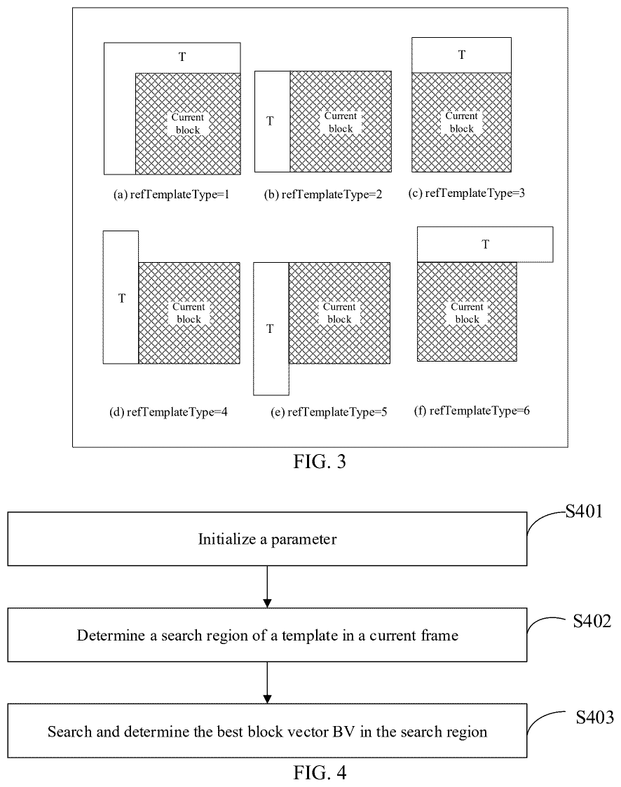

Referring to FIG. 4, FIG. 4 shows a schematic diagram of a search procedure based on the intra TMP technology according to an embodiment of this application. As shown in FIG. 4, the procedure may include the following steps.

S401: Initialize a parameter.

It should be noted that, an L-type template is used as an example, uiPatchWidth is initialized to nTbW+templateW_size, and uiPatchHeight is initialized to nTbH+templateH_size. TemplateW_size and templateH_size may be fixed constants, or may be dynamically adjusted according to a size of the current coding block. In addition, templateW_size and templateH_size may be equal or not equal to each other. For example, templateW_size=4, templateH_size=4. Alternatively, when a width of the current coding block is greater than 8, templateW_size=4; or when the width of the current coding block is less than or equal to 8, templateW_size=2. When the height of the current coding block is greater than 8, templateH_size=4. When the height of the current coding block is less than or equal to 8, templateH_size=2.

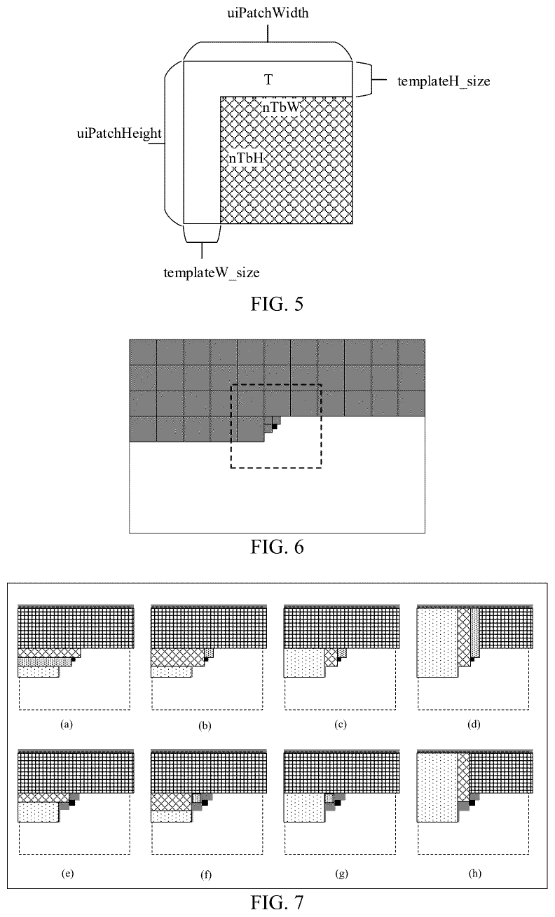

For example, FIG. 5 shows a schematic diagram of parameter definition of a current coding block and template thereof. As shown in FIG. 5, specific meanings of parameters are as follows: NTbW and nTbH represent sizes of the current coding block, templateW_size and templateH_size represent sizes of the template, and uiPatchWidth and uiPatchHeight represent sizes of a block that includes the current coding block and the template.

Further, a cost threshold diffThreshold between templates is initialized. For example, when the cost function is SAD, the threshold may be diffThreshold=((1<<bitDepth)>>2)×(uiPatchHeight×uiPatchWidth−nTbH×nTbW). When the image bit depth bitDepth is 10, diffThreshold indicates that a distortion threshold of each pixel in the template regin is 256.

Further, a location of an encoding tree block CTB in which the current coding block CB is located is initialized as: CtbRsX, ctbRsY.

Further, the location offset of the current coding block CB in the current CTB is initialized as: OffsetLCBY=yTbCmp−ctbRsY, offsetLCBX=xTbCmp−ctbRsX.

Further, iTemplateSizeH=templateH_size and iTemplateSizeW=templateW_size are initialized.

Further, iBvShift is initialized, and iBvShift is a precision of a block vector (BV). For example, the precision of the BV may be an integer pixel precision, and in this case, iBvShift is 0. The BV precision may alternatively be a sub-pixel precision. For example, when iBvShift is 1, it indicates ½ pixel precision, and when iBvShift is 2, it indicates ¼ pixel precision. This is not specifically limited herein.

Further, a preset search range of the template is initialized. The preset search range of the template may be set to a fixed size, or the search range may be dynamically adjusted according to a coding block size. For example, searchRangeWidth=TMP_SEARCH_RANGE_MULT_FACTOR×nTbW, searchRangeHeight=TMP_SEARCH_RANGE_MULT_FACTOR×nTbH. A value of TMP_SEARCH_RANGE_MULT_FACTOR may be a preset value, for example, 5.

S402. Determine a search region of a template in a current frame.

It should be noted that a search region in the Intra TMP technology is a reconstructed part of a current image, and is limited by a size of a search range. FIG. 6 is a schematic diagram of a template search region. As shown in FIG. 6, a background regin filled with dark color is a reconstructed regin, a background block filled with black is a current coding block, and a dotted line block is a search range window. Therefore, the search region of the IntraTMP technology is not greater than an overlapping part of the reconstructed regin of the dark background and the regin marked by the dotted line block.

It can be learned that the template search region of the current coding block may be a reconstructed part of the CTB in which the current coding block is located, or may be another reconstructed CTB regin. The search region herein is actually a set of all search points. A shape of the region is often not representable by a single rectangle. In specific implementations, a search may be performed in multiple rectangular regions, and a final best match block and a best block vector are obtained from search results of different regions.

For example, referring to FIG. 7, FIG. 7 shows a schematic diagram of different sub-region division of a search region. In FIG. 7, eight different sub-region division manners are shown. A block filled with black is a current coding block. The manners (a), (b), (c), (d), and (f) are all dividing the search region into four search sub-regions, and the manners (e), (g), and (h) are all dividing the search regin into three search sub-regions, where different filling patterns represent different search sub-regions.

In FIG. 7, the manners (a), (b), (c), and (d) consider all available search ranges, and manners (e), (f), (g), and (h) do not consider the direct above region and the direct left region.

For example, it is assumed that different search sub-regions are represented by different values of regionId. Considering that pixels of a template of the current coding block needs to be obtained in an image reconstructed regin and pixels of a reconstruction block corresponding to the template also needs to be obtained in the reconstructed regin, searchable positions in search sub-regions represented by different values of regionId need to be determined according to a location (xTbCmp, yTbCmp) of the current coding block, a size (nTbW, nTbH) of the current coding block, a size (picWidth, picHeight) of a current image, a size (CtbSizeW, CtbSizeH) of a CTB in which the current coding block is located, a preset search range (search RangeWidth, searchRangeHeight) of the template, and a location offset (offsetLCBY, offsetLCBX) of the current coding block in a current CTB, so as to obtain a block vector BV. Specifically, iVerMin and iVerMax are respectively used to represent absolute coordinates that are at least and at most searchable in a vertical direction, and iHorMin and iHorMax are respectively used to represent absolute coordinates that are at least and at most searchable in a horizontal direction. Different search sub-regions represented by different values of regionId have different values of iVerMin, iVerMax, iHorMin, and iHorMax.

The manner (f) in FIG. 7 is used as an example, in which the search region is divided into four search sub-regions. An implementation is as follows.

When regionId is equal to 0, iVerMin, iVerMax, iHorMin, and iHorMax may be calculated as follows:

$${iHorMax}_{0} = min ( ( xTbCmp + searchRangeWidth ) << iBvShift , ( ( picWidth - nTbW ) << iBvShift ) ) ;$$

$${iHorMin}_{0} = max ( ( iTemplateSizeW ) << iBvShift , ( xTbCmp - searchRangeWidth ) << iBvShift ) ;$$

$${iVerMax}_{0} = ( yTbCmp - nTbH - offsetLCBY ) << iBvShift ;$$

$${iVerMin}_{0} = max ( ( iTemplateSizeH ) << iBvShift ) , ( ( yTbCmp - searchRangeHeight ) << iBvShift ) ) .$$

When regionId is equal to 1, iVerMin, iVerMax, iHorMin, and iHorMax may be calculated as follows:

$${iHorMin}_{1} = max ( ( iTemplateSizeW ) << iBvShift , ( xTbCmp + searchRangeWidth ) << iBvShift ) ;$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( ( picHeight - nTbH ) << iBvShift , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$${iHorMax}_{2} = ( xTbCmp - offsetLCBX - nTbW ) << iBvShift ;$$

$${iHorMin}_{2} = max ( ( iTemplateSizeW ) << iBvShift , ( xTbCmp - searchRangeWidth ) << iBvShift ) ;$$

$${iVerMin}_{2} = max ( ( iTemplateSizeH ) << iBvShift , ( yTbCmp - nTbH - offsetLCBY ) << iBvShift ) ;$$

$${iVerMax}_{2} = ( yTbCmp ) << iBvShift .$$

When regionId is equal to 3, iVerMin, iVerMax, iHorMin, and iHorMax may be calculated as follows:

$${iHorMin}_{3} = max ( ( iTemplateSizeW ) << iBvShift , ( xTbCmp - offsetLCBX - nTbW + 1 ) << iBvShift ) ;$$

$${iHorMax}_{3} = ( xTbCmp - nTbW ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

In actual applications, iHorMinregionId, iHorMaxregionId, iVerMinregionId, and iVerMaxregionId herein respectively represent left edge, right edge, upper edge, and lower edge of different search sub-regions.

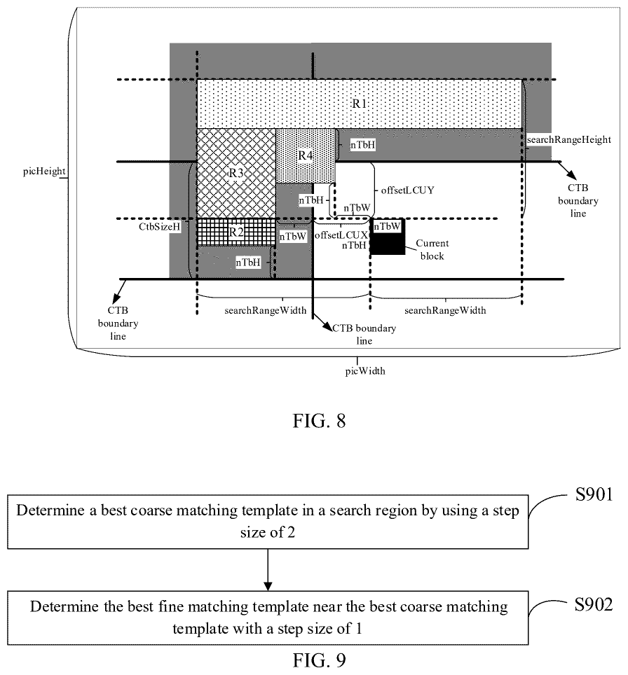

To intuitively describe different search sub-regions corresponding to different values of regionId, referring to FIG. 8, FIG. 8 shows a schematic diagram of a specific search region determining process. As shown in FIGS. 8, R1, R2, R3, and R4 represent four different search sub-regions. It should be noted that FIG. 8 shows the pixel ranges that can be aligned with the pixel in the upper left corner of a block.

S403: Search and determine the best block vector BV in the search region.

It should be noted that bvXMins and bvXMaxs respectively represent a minimum offset and a maximum offset of a block vector in a horizontal direction. The minimum offset and the maximum offset of the block vector in a vertical direction are represented by bvYMins and bvYMaxs respectively.

BvXMins_{regionId}, bvXMaxs_{regionId}, bvYMins_{regionId}, and bvYMaxs_{regionId} may be obtained by means of calculation by using iVerMin_{regionId}, iVerMax_{regionId} iHorMin_{regionId}, and iHorMax_{regionId} determined in step S402:

$${bvXMins}_{regionId} = {iHorMin}_{regionId} - xTbCmp ;$$

$${bvXMaxs}_{regionId} = {iHorMax}_{regionId} - xTbCmp ;$$

$${bvYMins}_{regionId} = {iVerMin}_{regionId} - xTbCmp ;$$

$${bvYMaxs}_{regionId} = {iVerMax}_{regionId} - xTbCmp ;$$

BvXMins_{regionId}, bvXMaxs_{regionId}, bvYMins_{regionId}, and bvYMaxs_{regionId} defines a horizontal and vertical offset range of a search point relative to the current coding block, that is, a range of the block vector BV.

It should be further noted that, a search point iPosHorin in each search region is represented by (iPosHor, iPox Ver), the block vector BV including a horizontal component and a vertical component is represented by (PX, pY)), where pX=iPosHor-xTbCmp and pY=iPosVer-yTbCmp, pX is between bvXMins and bvXMaxs, and pY is between bvYMins and bvYMaxs. In this way, a matching reconstruction block of the current coding block may be found in the reconstructed region, and adjacent reconstructed pixels of the matching reconstruction block form a matching template (that is, the foregoing second template). Therefore, the matching cost value of the neighboring template of the current coding block and the neighboring template of the matching reconstruction block can be calculated, which is denoted as pDiff.

Further, all search points in all search ranges (regionId=0, 1, 2, and 3) are traversed, and a search point with a minimum matching cost value pDiff is obtained by means of comparison, the corresponding matching cost value is denoted as pDiff_BEST, and the corresponding block vector BV is denoted as a best block vector BV_BEST (pX_BEST, pY_BEST), and the corresponding matching template is denoted as a best template T_BEST.

In a possible implementation, if the search policy is coarse search only, specific implementation is as follows.

In each regin, pX is in a search range between bvXMins_{regionId} and bvXMaxs_{regionId}, and pY is in a search range between bvYMins_{regionId} and bvYMaxs_{regionId}, and a coarse search is performed at a step size greater than 1. For example, the best matching cost value obtained by performing coarse search of a template at a step size of 2 is denoted as pDiff_BEST, and a corresponding block vector BV is denoted as a best block vector BV_BEST (pX_BEST, pY_BEST).

In another possible implementation, if the search policy is fine search only, specific implementation is as follows.

In each regin, pX is in a search range between bvXMins_{regionId} and bv XMaxs_{regionId}, and pY is in a search range between bvYMins_{regionId} and bvYMaxs_{regionId}. For example, the best matching cost value obtained by performing fine search of a template at a step size of 1 is pDiff_BEST, and a corresponding block vector BV is denoted as a best block vector BV_BEST (pX_BEST, pY_BEST).

In still another possible implementation, the search policy is coarse search before fine search. FIG. 9 is a schematic diagram of a search process. As shown in FIG. 9, the specific process is as follows.

S901. Determine a best coarse matching template in a search region by using a step size of 2.

S902: Determine the best fine matching template near the best coarse matching template with a step size of 1.

It should be noted that, for step S901, in the coarse search stage, the process is as follows.

In each regin, pX is in a search range between bvXMins_{regionId} and bvXMaxs_{regionId}, and pY is in a search range between bvYMins_{regionId} and bvYMaxs_{regionId}, and a coarse search is performed at a step size greater than 1. For example, the best matching cost value obtained by performing coarse search of a template at a step size of 2 is denoted as pDiff1_BEST, and a corresponding block vector BV is denoted as a best block vector BV1_BEST (pX1_BEST, pY1_BEST). A search region in which the best match search point is located is bestRegionId.

It should be further noted that, for step S902, in the fine search stage, the process is as follows.

Further search is performed near the best block vector BV1_BEST obtained by the coarse search. Specifically, a refined search range TmpRefineRange is first determined, and the refined search range may be of a fixed size, or may be related to a current coding block size, for example, may be set to min (nTbW, nTbH)/2. Then, a position of the optimal matching reconstruction block obtained by the coarse search is calculated as a reference position of the fine search region: BestPosX=xTbCmp+pX1_BEST, BestPosY=yTbCmp+pY1_BEST.

First, calculated values of iVerMin_{bestRegionId}, iVerMax_{bestRegionId}, iHorMin_{bestRegionId}, and iHorMax bestRegionId are obtained according to a value of bestRegionId, and then a new search range iVerMin_{refine}, iVerMax_{refine}, iHorMin_{refine}, and iHorMax_{refine} is obtained according to the location of the best matching block obtained the coarse search, as follows:

$${iHorMin}_{refine} = max ( {iHorMin}_{bestRegionId} , BestPosX - TmpRefineRange ) ;$$

$${iHorMax}_{refine} = min ( {iHorMax}_{bestRegionId} , BestPosX + TmpRefineRange ) ;$$

$${iVerMin}_{refine} = max ( {iVerMin}_{bestRegionId} , BestPosY - TmpRefineRange ) ;$$

$${iVerMax}_{refine} = min ( {iVerMax}_{bestRegionId} , BestPosY + TmpRefineRange ) ;$$

Then, the adjusted block vector BVbvXMins, bvXMaxs, bvYMins, and bvYMaxs may be calculated by using iVerMin_{refine}, iVerMax_{refine}, iHorMin_{refine}, and iHorMax_{refine}:

$$bvXMins = {iHorMin}_{refine} - xTbCmp ;$$

$$bvXMaxs = {iHorMax}_{refine} - xTbCmp ;$$

$$bvYMins = {iVerMin}_{refine} - yTbCmp ;$$

$$bvYMaxs = {iVerMax}_{refine} - yTbCmp ;$$

In this way, the fine search is performed in a range of pX between bvXMins_{refine} and bvXMaxs_{refine} and pY between bvYMins_{refine} and bvYMaxs_{refine}. For example, the search is performed by using a step size of 1. The best matching cost obtained by template matching is denoted as pDiff_BEST, and a corresponding block vector BV is denoted as the best block vector BV_BEST (pX_BEST, pY_BEST).

After the foregoing operations are completed, the best block vector BV_BEST (pX_BEST, pY_BEST) can be obtained, where pX_BEST and pY_BEST are respectively the horizontal and vertical offsets of the best matching template relative to the current coding block template, and are also the horizontal and vertical offsets of the best matching reconstruction block relative to the current coding block.

S204. Generate a predicted value.

Here, a simple translation copy may be used. A specific operation is as follows:

For x=0 . . . nTbW−1, y=0 . . . nTbH−1;

$$predSa mples [ x ] [ y ] = recSa mples [ x + pX\_BEST ] [ y + pY\_BEST ] \qquad ( 2 )$$

Where recSamples represents a reconstructed pixel of the current frame.

Briefly, in a related technology, the intra TMP technology searches, according to a preset cost function, a predefined search range in a current image for a matching template whose cost from a template of the current coding block is the smallest, and uses a best matching reconstruction block (Ref Block) corresponding to the matching template as a prediction block of the current coding block (Cur Block). The template of the current coding block is usually a reconstructed regin adjacent to the current coding block.

However, in an actual encoding process, the search strategy usually cannot fully utilize the adjacent reconstructed sample information, and consequently, the final obtained candidate block is not the best candidate block, so that valid reference information is limited, and finally prediction accuracy is reduced.

In conclusion, in a common decoding method, there may be a problem that a predicted value has a relatively large error, which leads to low prediction accuracy and cannot achieve an optimal prediction effect.

To resolve the foregoing problem, embodiments of this application provide a decoding method, an encoding method, an encoder, a decoder, and a storage medium. The encoder and decoder determines a first template corresponding to a current coding block; determines a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately searches the fully reconstructed search region and/or the to-be-determined reconstructed search region and determines one or more block vectors of the current coding block. It can be learned that, in embodiments of this application, an Intra TMP-BV prediction manner is proposed, a to-be-determined reconstructed search region and/or a fully reconstructed search region are determined, availability determination of each search position is added to a traversing process of the to-be-determined reconstructed search region, so as to full utilizing information about all adjacent reconstructed samples. That is, the encoding and decoding methods proposed in embodiments of this application fully consider, in a search process, importance of the to-be-determined reconstructed search region in which whether a sample point has been reconstructed is uncertain, to prediction of the current coding block, and available sample points in the to-be-determined reconstructed search region are fully used, so that prediction accuracy can be improved, and an optimal prediction effect can be obtained.

The following describes the embodiments of this application in detail with reference to the accompanying drawings.

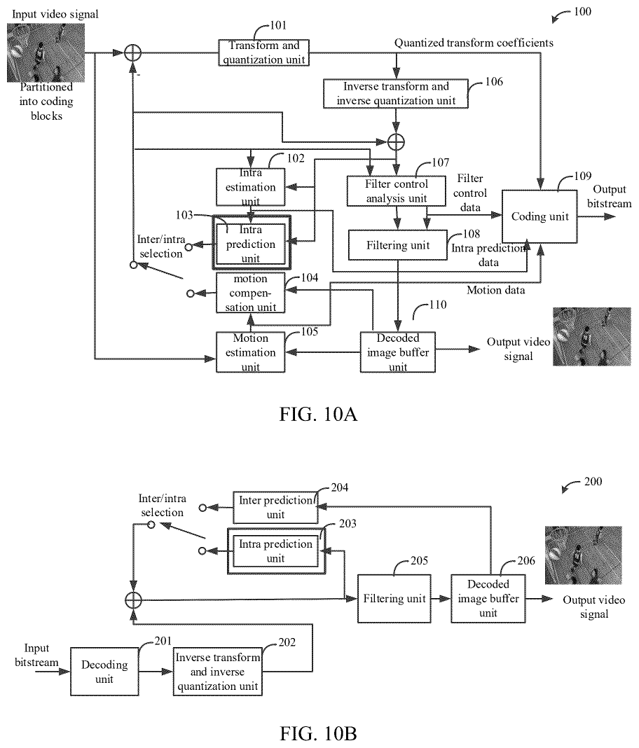

FIG. 10A shows a schematic diagram of an encoder according to an embodiment of the present disclosure. As shown in FIG. 10A, the encoder (specifically “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, and a decoded image buffer unit 110. The filtering unit 108 may implement de-block filtering and sample adaptive offset (Sample Adaptive Offset, SAO) filtering, and the coding unit 109 may implement header information encoding and context-based adaptive binary arithmetic coding (Context-based Adaptive Binary Arithmetic Coding, CABAC). For an inputted original video signal, a video coding block may be obtained by means of partitioning into coding tree blocks (Coding Tree Unit, CTU), and then residual pixel information obtained after intra or inter prediction is transformed by the transform and quantization unit 101. The transform includes converting residual information from a pixel field to a transform field, and quantizing the obtained transform coefficients, so as to further reduce a bit rate. The intra estimation unit 102 and the intra prediction unit 103 are used to perform intra prediction on the video coding block. Specifically, the intra estimation unit 102 and the intra prediction unit 103 are used to determine an intra prediction mode to be used for encoding the video coding block. The motion compensation unit 104 and the motion estimation unit 105 are configured to execute inter prediction encoding on the received video coding block relative to one or more blocks in one or more reference frames to provide time prediction information. The motion estimation executed by the motion estimation unit 105 is a process of generating a motion vector, and the motion vector may be used to estimate a motion of the video coding block, and then the inter prediction unit 104 executes motion compensation based on the motion vector determined by the motion estimation unit 105. After determining the intra prediction mode, the intra prediction unit 103 is further configured to provide the selected intra prediction data to the coding unit 109, and the motion estimation unit 105 also sends the calculated motion vector data to the coding unit 109. In addition, the inverse transform and inverse quantization unit 106 is used to reconstruct the video coding block, which reconstructs the residual block in the pixel domain. The reconstructed residual block is processed by the filter control analysis unit 107 and the filter unit 108 to remove the block effect artifact, and then is added to a prediction block in a frame stored in the decoded image buffer unit 110 to generate the reconstructed video coding block. The coding unit 109 is used to encode various encoding parameters and quantized transform coefficients. In the CABAC-based encoding algorithm, context content may be based on adjacent coding blocks, and used to code an indication of the determined intra prediction mode, to output a bitstream of the video signal. The decoded image buffer unit 110 is configured to store the reconstructed video coding block, to be used for prediction reference. As the video image encoding progresses, new reconstructed video coding blocks are continuously generated, and these reconstructed video coding blocks are stored in the decoded image buffer unit 110.

FIG. 10B shows a schematic diagram of a decoder according to an embodiment of this application. As shown in FIG. 10B, a decoder (specifically “video decoder”) 200 includes a decoding unit 201, an inverse transform and inverse quantization unit 202, an intra prediction unit 203, a motion compensation unit 204, a filtering unit 205, a decoded image buffer unit 206, and the like. The decoding unit 201 may implement header information decoding and CABAC decoding, and the filtering unit 205 may implement de-block filtering and SAO filtering. After the input video signal is processed by using the encoder in FIG. 10A, a bitstream of the video signal is output. The bitstream is inputted to the decoder 200. Firstly, the bitstream is processed by the decoding unit 201 to obtain decoded transform coefficients. The transform coefficients are processed by the inverse transform and inverse quantization unit 202, so as to generate a residual block in the pixel domain. The intra prediction unit 203 may be configured to generate prediction data of the current video decoding block based on the determined intra prediction mode and previously decoded block data from the current frame or picture. The motion compensation unit 204 determines prediction information for the video decoding block by parsing the motion vector and other related syntax element, and uses the prediction information to generate a prediction block for a video decoding block being decoded. A decoded video block is formed by summing the residual block from the inverse transform and inverse quantization unit 202 and the corresponding prediction block generated by the intra prediction unit 203 or the motion compensation unit 204. A decoded video signal passes through the filtering unit 205, so as to remove a block effect artifact, thereby improving video quality. Then, the decoded video block is stored in the decoded image buffer unit 206. The decoded image buffer unit 206 stores a reference image that is used for subsequent intra prediction or motion compensation, and is also used for output of the video signal, to obtain the recovered original video signal.

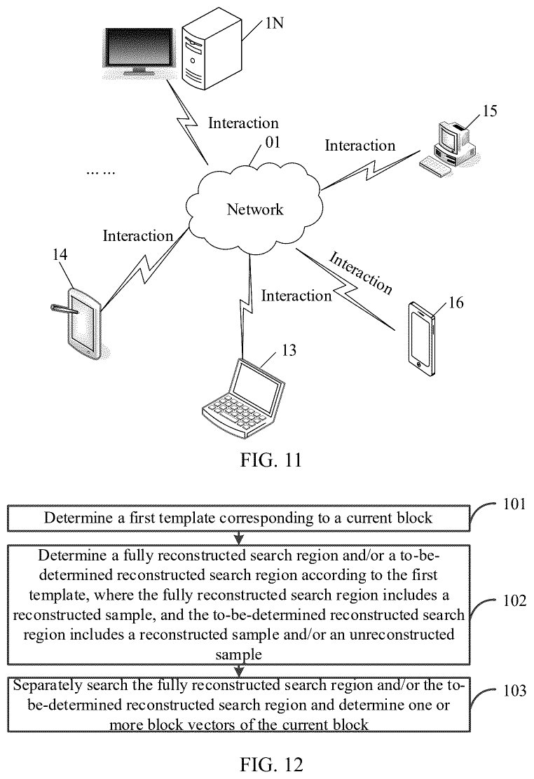

Further, an embodiment of this application further provides a network architecture of a coding system that includes an encoder and a decoder. FIG. 11 shows a schematic diagram of a network architecture of a coding system according to an embodiment of this application. As shown in FIG. 11, the network architecture includes one or more electronic devices 13 to 1N and a communications network 01, where the electronic devices 13 to 1N may perform video interaction by using the communications network 01. In practices, the electronic devices may be various types of devices that have a video coding function. For example, the electronic devices may include a smartphone, a tablet computer, a personal computer, a personal digital assistant, a navigator, a digital telephone, a video telephone, a television, a sensing device, and a server. This is not specifically limited in some embodiments of this application. Herein, the decoder or the encoder described in some embodiments of this application may be the foregoing electronic devices.

It should be noted that the method in some embodiments of this application is mainly applied to the intra prediction unit 103 part shown in FIG. 10A and the intra prediction unit 203 part shown in FIG. 10B. That is, embodiments of this application may be applied to the encoder or the decoder, or may even be applied to both the encoder and the decoder. However, embodiments of this application set no specific limitation thereto.

It should be further noted that when applied to the intra prediction unit 103, the “current coding block” specifically refers to a current encoding block for performing intra prediction; and when applied to the intra prediction unit 203, the “current coding block” specifically refers to a current decoding block for performing intra prediction.

An embodiment of this application provides a decoding method. The decoding method is applied to a decoder. FIG. 12 is a schematic flowchart of a decoding method according to an embodiment of this application. As shown in FIG. 12, the method for performing a decoding process by a decoder may include the following steps.

Step 101: Determine a first template corresponding to a current coding block.

In some embodiments of this application, the first template corresponding to the current coding block may be first determined. When obtaining the first template, a template type corresponding to the current coding block may be first determined, and then the first template corresponding to the current coding block may be further determined according to the template type.

It should be noted that the decoding method in some embodiments of this application is applied to a decoder. In addition, the decoding method may include an intra prediction method, and more specifically, a color component prediction method. The video image may be divided into multiple decoding blocks, and each decoding block may include a first color component, a second color component, and a third color component. In some embodiments of this application, the current coding block refers to a decoding block that is in the video image and that is currently to be used for performing intra prediction.

Herein, when the first color component is to be predicted, the to-be-predicted component is the first color component; when the second color component is to be predicted, the to-be-predicted component is the second color component; and when the third color component is to be predicted, the to-be-predicted component is the third color component. In addition, assuming that the current coding block is used to predict the first color component, and the first color component is a luma component, the to-be-predicted component is the luma component, and the current coding block may also be referred to as a luma block. Alternatively, assuming that the current coding block is used to predict a second color component, and the second color component is a chroma component, the to-be-predicted component is the chroma component, and the current coding block may also be referred to as a chroma block.

It should be further noted that in some embodiments of this application, the reference pixel (Reference Sample) of the current coding block may be a reference pixel adjacent to the current coding block. The “adjacent” herein may be adjacent in space, but is not limited thereto. For example, the “adjacent” may be “adjacent” in the time domain, or “adjacent” in space and in the time domain. Alternatively, a reference pixel of a current coding block may even be a reference pixel obtained by performing some processing on a pixel adjacent in space, or adjacent in the time domain, or adjacent in space and in the time domain, which is not limited in some embodiments of this application.

Further, in some embodiments of this application, the template type of the current coding block may be determined according to indication information in a bitstream. Alternatively, the template type of the current coding block may be determined according to the size of the current coding block.

Further, in some embodiments of this application, the template type of the current coding block may be determined according to a reference pixel of the current coding block. The reference pixel of the current coding block includes at least one of the following: a left adjacent reference pixel of the current coding block, an above adjacent reference pixel of the current coding block, an above left adjacent reference pixel of the current coding block, a below left adjacent reference pixel of the current coding block, or an above right adjacent reference pixel of the current coding block.

It may be understood that in some embodiments of this application, the reference pixel of the current coding block may include an adjacent reconstructed pixel of the current coding block, that is, adjacent reconstructed pixels of the current coding block may be used as a template to search for a matching template in a predefined search region.

It should be noted that in some embodiments of this application, the reference pixel of the current coding block, that is, the adjacent reconstructed pixel of the current coding block may include an above reference pixel, an above left reference pixel, an above right reference pixel, a left reference pixel, or a below left reference pixel of the current coding block.

It may be understood that, in some embodiments of this application, when determining the template type of the current coding block by using the reference pixel of the current coding block, the template type may be determined according to whether the adjacent reference pixel is available.

It may be understood that, in some embodiments of this application, when determining the template type of the current coding block, the template type may be determined according to an indication in the bitstream.

Further, in some embodiments of this application, when determining the template type of the current coding block according to the reference pixel of the current coding block, if a left adjacent reference pixel of the current coding block, an above adjacent reference pixel of the current coding block, and an above left adjacent reference pixel of the current coding block are all available, the template type of the current coding block is determined as a first value; if a left adjacent reference pixel of the current coding block is available, the template type of the current coding block is determined as a second value; if an above adjacent reference pixel of the current coding block is available, the template type of the current coding block is determined as a third value; if a left adjacent reference pixel of the current coding block and an above left adjacent reference pixel of the current coding block are available, the template type of the current coding block is determined as a fourth value; if a left adjacent reference pixel of the current coding block and a below left adjacent reference pixel of the current coding block are available, the template type of the current coding block is determined as a fifth value; and if an above adjacent reference pixel of the current coding block and an above right adjacent reference pixel of the current coding block are available, the template type of the current coding block is determined as a sixth value.

It should be noted that, in some embodiments of this application, the first value, the second value, the third value, the fourth value, the fifth value, and the sixth value may be any values, which is not specifically limited in this application. For example, values of the first value, the second value, the third value, the fourth value, the fifth value, and the sixth value may be sequentially 1, 2, 3, 4, 5, and 6.

For example, in some embodiments of this application, refTemplateType may be used to represent a template type. Correspondingly, as shown in FIG. 3, the block that is filled with grids is a current coding block, and a region adjacent to the current coding block is a template T. Six template types are shown herein.

For example, the six template types are as follows. When the above left reference pixel, the above reference pixel, and the left reference pixel are all available, a value of refTemplateType is 1, and a template shape is as shown in (a) in FIG. 3. When only the left reference pixel is available, the value of refTemplate Type is 2, and the template shape is as shown in (b) in FIG. 3. When only the above reference pixel is available, the value of refTemplateType is 3, and the template shape is as shown in (c) in FIG. 3. When only the left reference pixel and the above left reference pixel are available, the value of refTemplateType is 4, and the template shape is as shown in (d) in FIG. 3. When only the left reference pixel and the below left reference pixel are available, the value of refTemplateType is 5, and the template shape is as shown in (e) in FIG. 3. When only the above reference pixel and the above right reference pixel are available, the value of refTemplateType is 6, and the template shape is as shown in (f) in FIG. 3.

In some embodiments, the foregoing reference pixel availability information may also be combined with an indication in the bitstream to determine the template type of the IntraTMP. For example, a sequence number of each template type is agreed, and the bitstream transmits a sequence number of an actually used template, so that the decoding side can determine the template type.

That is, in some embodiments of this application, the template type may be determined according to the availability information of the reference pixel of the current coding block, or the template type may be determined according to the information indicated in the bitstream, or may be determined with reference to the availability information of the reference pixel and the information indicated in the bitstream. This application sets no specific limitation.

Further, in some embodiments of this application, when determining the first template corresponding to the current coding block according to the template type, template reference pixels of the current coding block may be first determined according to the template type and a template size corresponding to the template type, and then the first template of the current coding block may be determined according to the template reference pixels.

It should be noted that in some embodiments of this application, the first template of the current coding block may include template reference pixels of the current coding block. The template reference pixels of the current coding block may be determined according to the template type of the current coding block and the template size corresponding to the template type.

It should be noted that in some embodiments of this application, the first template of the current coding block may be formed by reconstructed pixels in one or more of an above region, an above right region, a left region, a below left region, or an above left region of the current coding block, that is, may be formed by reference pixels of the current coding block.

It should be noted that in some embodiments of this application, a template size corresponding to the template type may be preset, may be indicated by a bitstream syntax element, or may be selected adaptively according to a block size or other information. For example, when the left template is obtained, the template width templateW_size may be set to 4, and when the above template is obtained, the template height templateH_size may be set to 4.

Correspondingly, in some embodiments of this application, with reference to a value of the template type refTemplateType of the current coding block and a template size corresponding to the refTemplate Type, a part of reconstructed pixels may be obtained as template reference pixels of the current coding block, and then a corresponding first template may be determined.

For example, in some embodiments of this application, when the value of refTemplate Type is 1, left, above left, and above reconstructed pixels of the current coding block may be selected. When the value of refTemplateType is 2, only four columns of left reconstructed pixel of the current coding block are obtained. When the value of refTemplateType is 3, only four rows of above reconstructed pixels of the current coding block are obtained.

Certainly, a preset value of the template size may be any integer greater than 0, and is not limited to 4. This is not specifically limited in this application.

It may be understood that, in some embodiments of this application, with reference to the template type of the current coding block and the corresponding template size, the template reference pixels of the current coding block determined from the reference pixels of the current coding block may form the first template corresponding to the current coding block.

Step 102: Determine a fully reconstructed search region and/or a to-be-determined reconstructed search region according to the first template. The fully reconstructed search region includes a reconstructed sample, and the to-be-determined reconstructed search region includes a reconstructed sample and/or an unreconstructed sample.

In some embodiments of this application, after the first template corresponding to the current coding block is determined, a fully reconstructed search region and/or a to-be-determined reconstructed search region may be further determined according to the first template. The fully reconstructed search region includes a reconstructed sample, and the to-be-determined reconstructed search region includes a reconstructed sample and/or an unreconstructed sample.

It may be understood that in some embodiments of this application, in a prediction process of Intra TMP, the search region selected based on the first template may include a to-be-determined reconstructed search region and/or a fully reconstructed search region. The fully reconstructed search region may include only reconstructed samples, that is, all samples in the fully reconstructed search region are reconstructed samples. For the to-be-determined reconstructed search region, it is not certain whether a sample in the to-be-determined reconstructed search region has been reconstructed. That is, the to-be-determined reconstructed search region may include only reconstructed samples, may include only unreconstructed samples, or may include both a reconstructed sample and an unreconstructed sample.

Correspondingly, in a process of traversing a to-be-determined reconstructed search region, availability of each search position needs to be determining, so as to fully utilize information about all adjacent reconstructed samples.

It should be noted that in some embodiments of this application, a process of searching for a block vector may include steps of initialization, determining a search region of the first template in a current frame, and searching the search region and determining one or more best block vectors. Therefore, when performing search processing, an initialization process needs to be completed first.

For example, as shown in FIG. 5, nTbW and nTbH represent sizes of the current coding block, templateW_size and templateH_size represent template sizes, and uiPatchWidth and uiPatchHeight represent sizes of a block that include the current coding block and the template.

Correspondingly, in the initialization process, uiPatchWidth may be initialized to nTbW+templateW_size, and uiPatchHeight may be initialized to nTbH+templateH_size, where templateW_size and templateH_size may be fixed constants, or may be indicated by a bitstream syntax element, or may be dynamically adjusted according to a coding block size or other information. TemplateW_size and templateH_size may be constant or not constant. For example, templateW_size=4 and templateH_size=4. Alternatively, when the width of the coding block is greater than 8, the templateW_size=4 is set. When the width of the coding block is less than or equal to 8, the templateW_size=2 is set. When the height of the coding block is greater than 8, the templateH_size=4 is set. When the height of the coding block is less than or equal to 8, the templateH_size=2 is set.

Further, a cost threshold between templates is initialized and represented as diffThreshold. For example, when the cost function is SAD, the threshold may be diffThreshold=((1<<bitDepth)>>2)×(uiPatchHeight×uiPatchWidth−nTbH×nTbW). When the image bit depth bitDepth is 10, diffThreshold indicates that a distortion threshold of each pixel in the template regin is 256.

Further, a location of the coding tree block (CTB) in which the current coding block CB is initialized as: CtbRsX, ctbRsY.

Further, the location offset of the current coding block CB in the current CTB is initialized: OffsetLCBY=yTbCmp-ctbRsY, offsetLCBX=xTbCmp-ctbRsX.

Further, initialization of iTemplateSizeH−templateH_size and iTemplateSizeW=templateW_size are performed.

Further, iBvShift is initialized, and iBvShift represents a precision of the block vector (BV). For example, the precision of the BV may be an integer pixel precision, and in this case, iBvShift is 0. The BV precision may be a sub-pixel precision. For example, when iBvShift is 1, it indicates ½ pixel precision, and when iBvShift is 2, it indicates ¼ pixel precision. This is not specifically limited herein.

Further, a preset search range of the template is initialized, and the preset search range of the template may be set to a fixed size, or the search range may be dynamically adjusted according to a coding block size. For example, searchRangeWidth=TMP_SEARCH_RANGE_MULT_FACTOR×nTbW, searchRangeHeight=TMP_SEARCH_RANGE_MULT_FACTOR×nTbH. The value of TMP_SEARCH_RANGE_MULT_FACTOR may be a preset value, or may be indicated by using a bitstream syntax element, or may be adaptively adjusted according to information such as a coding block size. For example, it is set to 5.

Further, in some embodiments of this application, when determining the one or more block vectors corresponding to the current coding block according to the first template, the fully reconstructed search region may be first determined according to the first template. Then, a search may be performed in the fully reconstructed search region to determine one or more block vectors.

It should be noted that, in some embodiments of this application, the search region is a reconstructed part of the current image, and is limited by a size of a search range. As shown in FIG. 6, a background regin filled with a dark color is a reconstructed regin, a block filled with black is a current coding block, and a dotted line block is a search range window. Therefore, the search region of the IntraTMP technology is not greater than an overlapping part of the reconstructed regin of the dark background and the regin marked by the dotted line block.

It can be learned that the search region of the current coding block template may be a reconstructed part of the CTB in which the current coding block is located, or may be another reconstructed CTB regin. The search region herein is actually a set of all search points. A shape of the region is often not representable by a single rectangle. In specific implementations, a search may be performed in multiple rectangular regions, and a final best match block and a best block vector are obtained from search results of different regions.

For example, in some embodiments, the reconstructed regin in the dotted line block as shown in FIG. 6 may be divided into multiple regions, and upper and lower boundaries of each regin are determined, and then a search is performed in each of the multiple rectangular regions, and a final best matching block and a best block vector are obtained from the search results of the regions.

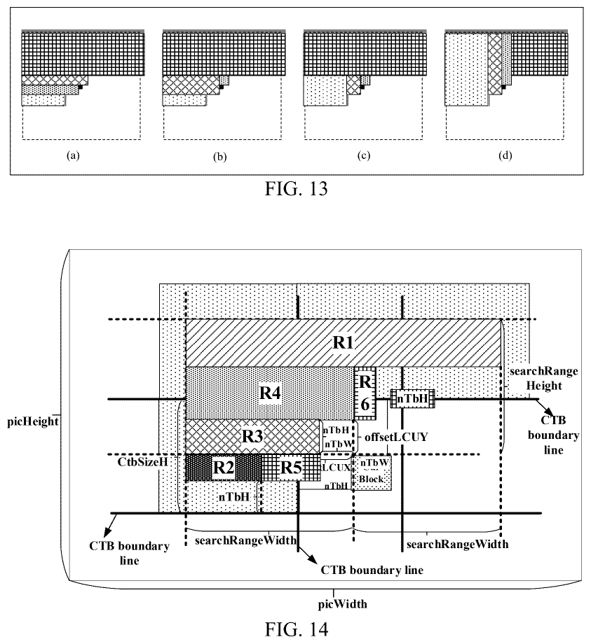

For example, referring to FIG. 13, four different sub-region division manners are shown herein. As shown in FIG. 13, a block filled with black is a current coding block. The manners (a), (b), (c), and (d) all dividing the search region into four search sub-regions, where different filling patterns represent different search sub-regions. The manners (a), (b), (c), and (d) consider all available search ranges.

For example, it is assumed that different search sub-regions are represented by different values of regionId. Considering that pixels of a template of the current coding block needs to be obtained in an image reconstructed regin and pixels of a reconstruction block corresponding to the template also needs to be obtained in the reconstructed regin, searchable positions in search sub-regions represented by different values of regionId need to be determined according to a location (xTbCmp, yTbCmp) of the current coding block, a size (nTbW, nTbH) of the current coding block, a size (picWidth, picHeight) of a current image, a size (CtbSizeW, CtbSizeH) of a CTB in which the current coding block is located, a preset search range (search RangeWidth, searchRangeHeight) of the template, and a location offset (offsetLCBY, offsetLCBX) of the current coding block in a current CTB, so as to determine a block vector (BV). Specifically, iVerMin and iVerMax are respectively used to represent absolute coordinates that are at least and at most searchable in a vertical direction, and iHorMin and iHorMax are respectively used to represent absolute coordinates that are at least and at most searchable in a horizontal direction. Different search sub-regions represented by different values of regionId have different values of iVerMin, iVerMax, iHorMin, and iHorMax.

Further, in some embodiments of this application, the search region may be divided according to the shape of the reconstructed region and the certainty of availability of reconstructed pixels, which can balance the operation complexity and coding efficiency. For example, a CTB regin encoded before the CTB in which the current coding block is located, a region that is in the CTB in which the current coding block is located and is located in the above left region, direct left region, and direct above region of the current coding block all belong to a certainly reconstructed regin. Therefore, such a region in which all included samples are certainly reconstructed is determined as a fully reconstructed search region. Correspondingly, in the CTB in which the current coding block is located, a region located in a below left region and an above right region of the current coding block belongs to a region that may be or may not be reconstructed. Therefore, such a region in which all the included samples are uncertainly reconstructed is determined as a to-be-determined reconstruction search region.

In some embodiments, based on consideration of the fully reconstructed search region and the to-be-reconstructed regin, a search region is divided into six search sub-regions, using (a) in FIG. 13 as an example. An implementation manner thereof is as follows.

When regionId is equal to 0, iVerMin, iVerMax, iHorMin, and iHorMax may be calculated as follows:

$${iHorMax}_{0} = min ( ( xTbCmp + searchRangeWidth ) << iBvShift , ( ( picWidth - nTbW ) << iBvShift ) ) ;$$

$${iHorMin}_{0} = max ( ( iTemplateSizeW ) << iBvShift , ( xTbCmp - searchRangeWidth ) << iBvShift ) ;$$

$${iVerMax}_{0} = ( yTbCmp - nTbH - offsetLCBY ) << iBvShift ;$$

$${iVerMin}_{0} = max ( ( iTemplateSizeH ) << iBvShift ) , ( ( yTbCmp - searchRangeHeight ) << iBvShift ) ) .$$

When regionId is equal to 1, iVerMin, iVerMax, iHorMin, and iHorMax may be calculated as follows:

$${iHorMin}_{1} = max ( ( iTemplateSizeW ) << iBvShift , ( xTbCmp + searchRangeWidth ) << iBvShift ) ;$$

$${iHorMax}_{1} = ( xTbCmp - offsetLCBX - nTbW ) << iBvShift ;$$

$${iVerMin}_{1} = ( yTbCmp + 1 ) << iBvShift ;$$

$${iVerMax}_{1} = min ( ( picHeight - nTbH ) << iBvShift , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$${iHorMax}_{2} = ( xTbCmp - offsetLCBX - nTbW ) << iBvShift ;$$

$${iHorMin}_{2} = max ( ( iTemplateSizeW ) << iBvShift , ( xTbCmp - searchRangeWidth ) << iBvShift ) ;$$

$${iVerMin}_{2} = max ( ( iTemplateSizeH ) << iBvShift , ( yTbCmp - nTbH - offsetLCBY ) << iBvShift ) ;$$

$${iVerMax}_{2} = ( yTbCmp ) << iBvShift .$$

When regionId is equal to 3, iVerMin, iVerMax, iHorMin, and iHorMax may be calculated as follows:

$${iHorMin}_{3} = max ( ( iTemplateSizeW ) << iBvShift , ( xTbCmp - offsetLCBX - nTbW + 1 ) << iBvShift ) ;$$

$${iHorMax}_{3} = ( xTbCmp - nTbW ) << iBvShift ;$$

$${iVerMin}_{3} = max ( ( ( iTemplateSizeH ) << iBvShift ) , ( yTbCmp - offsetLCBY - nTbH + 1 ) << iBvShift ) ;$$

$${iVerMax}_{3} = ( yTbCmp - nTbH ) << iBvShift .$$

When regionId is equal to 4, iVerMin, iVerMax, iHorMin, and iHorMax may be calculated as follows:

$$iHorMin = ( xTbCmp - offsetLCBX - nTbW ) << iBvShift ;$$

$$iHorMax = ( xTbCmp - nTbW ) << iBvShift ;$$

$$iVerMin = ( yTbCmp + 1 ) << iBvShift ;$$

$$iVerMax = min ( ( picHeight - nTbH ) << iBvShift , ( yTbCmp - offsetLCBY + CtbSizeH - nTbH + 1 ) << iBvShift ) .$$

When regionId is equal to 5, iVerMin, iVerMax, iHorMin, and iHorMax may be calculated as follows:

$$iHorMin = ( xTbCmp ) << iBvShift ;$$

$$iHorMax = min ( ( xTbCmp + CtbSizeW - nTbW ) << iBvShift , min ( ( xTbCmp + searchRangeWidth ) << iBvShift , ( ( picWidth - nTbW ) << iBvShift ) ) ) ;$$

$$iVerMin = max ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift .$$

In actual applications, iHorMin_{regionId}, iHorMax_{regionId}, iVerMin_{regionId}, and iVerMax_{regionId} herein respectively represent left edge, right edge, upper edge, and lower edge of different search sub-regions.

To intuitively describe different search sub-regions corresponding to different values of regionId, FIG. 14 is a second schematic diagram of a search region determining process. As shown in FIGS. 14, R1, R2, R3, R4, R5, and R6 represent six different search sub-regions, where R1, R2, R3, and R4 are fully reconstructed search regions, and R5 and R6 are to-be-determined reconstructed search regions. It should be noted that FIG. 14 shows the pixel ranges that can be aligned with the pixel in the upper left corner of a block.

That is, in some embodiments, a search region may be divided into two types, one is a type of search region in which all samples are certainly reconstructed (referred to as a fully reconstructed search region), for example, the four regions R1, R2, R3, and R4 in FIG. 14; the other one is a type of search region in which all samples are uncertainly reconstructed (referred to as a to-be-determined reconstructed search region), for example, the two regions R5 and R6 in FIG. 14.

In some embodiments, based on consideration of the fully reconstructed search region and the to-be-reconstructed regin, a search region is divided into six search sub-regions, using (b) in FIG. 13 as an example. An implementation manner thereof is as follows.

When regionId is equal to 0, iVerMin, iVerMax, iHorMin, and iHorMax may be calculated as follows:

$$iHorMax = min ( ( xTbCmp + searchRangeWidth ) << iBvShift , ( ( picWidth - nTbW ) << iBvShift ) ) ;$$

$$iHorMin = max ( ( iTemplateSizeW ) << iBvShift , ( xTbCmp + searchRangeWidth ) << iBvShift ) ;$$

$$iVerMax = ( yTbCmp - nTbH - offsetLCBY ) << iBvShift ;$$

$$iVerMin = max ( ( iTemplateSizeH ) << iBvShift ) , ( yTbCmp + searchRangeHeight ) << iBvShift ) .$$

When regionId is equal to 1, iVerMin, iVerMax, iHorMin, and iHorMax may be calculated as follows:

$$iHorMin = max ( ( iTemplateSizeW ) << iBvShift , ( xTbCmp - searchRangeWidth ) << iBvShift )$$

$$iHorMax = ( xTbCmp - offsetLCBX - nTbW ) << iBvShift ;$$

$$iVerMin = ( yTbCmp + 1 ) << iBvShift ;$$

$$iVerMax = max ( picHeight - nTbH ) , ( yTbCmp - offsetLCBY + CtbSizeH - nTbH ) << iBvShift ) .$$

When regionId is equal to 2, iVerMin, iVerMax, iHorMin, and iHorMax may be calculated as follows:

$$iHorMax = ( xTbCmp - nTbW ) << iBvShift ;$$

$$iHorMin = max ( ( iTemplateSizeW ) << iBvShift , ( xTbCmp + searchRangeWidth ) << iBvShift ) ;$$

$$iVerMin = max ( ( iTemplateSizeH ) << iBvShift , ( yTbCmp - nTbH - offsetLCBY ) << iBvShift ) ;$$

$$iVerMax = ( yTbCmp ) << iBvShift ) .$$

When regionId is equal to 3, iVerMin, iVerMax, iHorMin, and iHorMax may be calculated as follows:

$$iHorMin = min ( ( xTbCmp + searchRangeWidth ) << iBvShift , ( ( picWidth - nTbW ) << iBvShift ) ;$$

$$iHorMax = ( xTbCmp ) << iBvShift ;$$

$$iVerMin = max ( ( iTemplateSizeH ) << iBvShift ) , ( yTbCmp - offsetLCBY - nTbH + 1 ) << iBvShift ;$$

$$iVerMax = ( yTbCmp - nTbH ) << iBvShift .$$

When regionId is equal to 4, iVerMin, iVerMax, iHorMin, and iHorMax may be calculated as follows:

$$iHorMin = ( xTbCmp - offsetLCBX - nTbW ) << iBvShift ;$$

$$iHorMax = ( xTbCmp - nTbW ) << iBvShift ;$$

$$iVerMin = ( yTbCmp + 1 ) << iBvShift ) ;$$

$$iVerMax = min ( picHeight - nTbH ) , ( yTbCmp - offsetLCBY + CtbSizeH - nTbH ) << iBvShift ) .$$

When regionId is equal to 5, iVerMin, iVerMax, iHorMin, and iHorMax may be calculated as follows:

$$iHorMin = ( xTbCmp ) << iBvShift ;$$

$$iHorMax = min ( ( xTbCmp + CtbSizeW - nTbW ) << iBvShift , min ( ( xTbCmp + searchRangeWidth ) << iBvShift , ( ( picWidth - nTbW ) << iBvShift ) ) ) ;$$

$$iVerMin = max ( ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift .$$

In actual applications, iHorMin_{regionId}, iHorMax_{regionId}, iVerMin_{regionId}, and iVerMax_{regionId} herein respectively represent left edge, right edge, upper edge, and lower edge of different search sub-regions.

To intuitively describe different search sub-regions corresponding to different values of regionId, FIG. 15 is a third schematic diagram of a search region determining process. As shown in FIGS. 15, R1, R2, R3, R4, R5, and R6 represent six different search sub-regions, where R1, R2, R3, and R4 are fully reconstructed search regions, and R5 and R6 are to-be-determined reconstructed search regions. It should be noted that FIG. 15 shows the pixel ranges that can be aligned with the pixel in the upper left corner of a block.

That is, in some embodiments, a search region may be divided into two types, one is a type of search region in which all samples are certainly reconstructed (referred to as a fully reconstructed search region), for example, the four regions R1, R2, R3, and R4 in FIG. 15; the other one is a type of search region in which all samples are uncertainly reconstructed (referred to as a to-be-determined reconstructed search region), for example, the two regions R5 and R6 in FIG. 15.

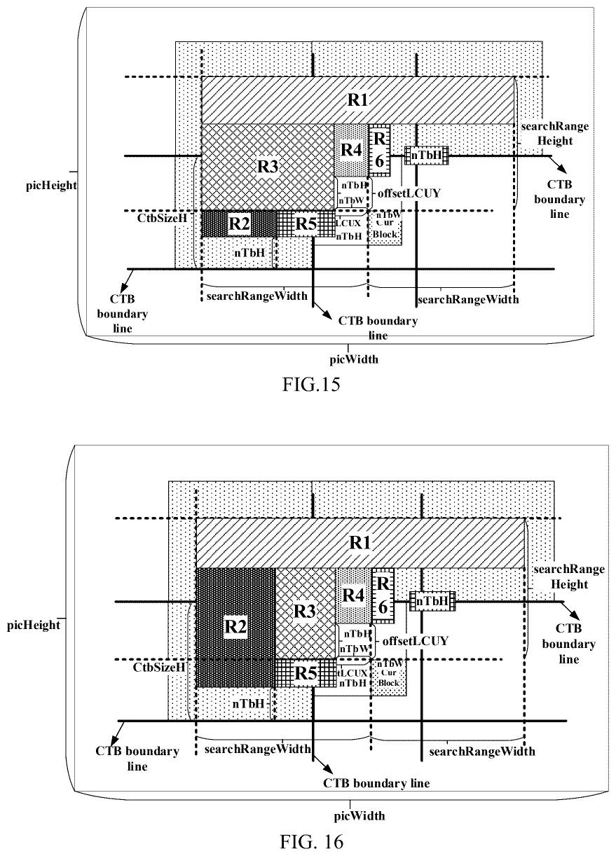

In some embodiments, based on consideration of the fully reconstructed search region and the to-be-reconstructed regin, the search region is divided into six search sub-regions, using (c) in FIG. 13 as an example. To intuitively describe different search sub-regions corresponding to different values of regionId, FIG. 16 is a fourth schematic diagram of a search region determining process. As shown in FIGS. 16, R1, R2, R3, R4, R5, and R6 represent six different search sub-regions, where R1, R2, R3, and R4 are fully reconstructed search regions, and R5 and R6 are to-be-determined reconstructed search regions. It should be noted that FIG. 16 shows the pixel ranges that can be aligned with the pixel in the upper left corner of a block.

That is, in some embodiments, a search region may be divided into two types, one is a type of search region in which all samples are certainly reconstructed (referred to as a fully reconstructed search region), for example, the four regions R1, R2, R3, and R4 in FIG. 16; the other one is a type of search region in which all samples are uncertainly reconstructed (referred to as a to-be-determined reconstructed search region), for example, the two regions R5 and R6 in FIG. 16.

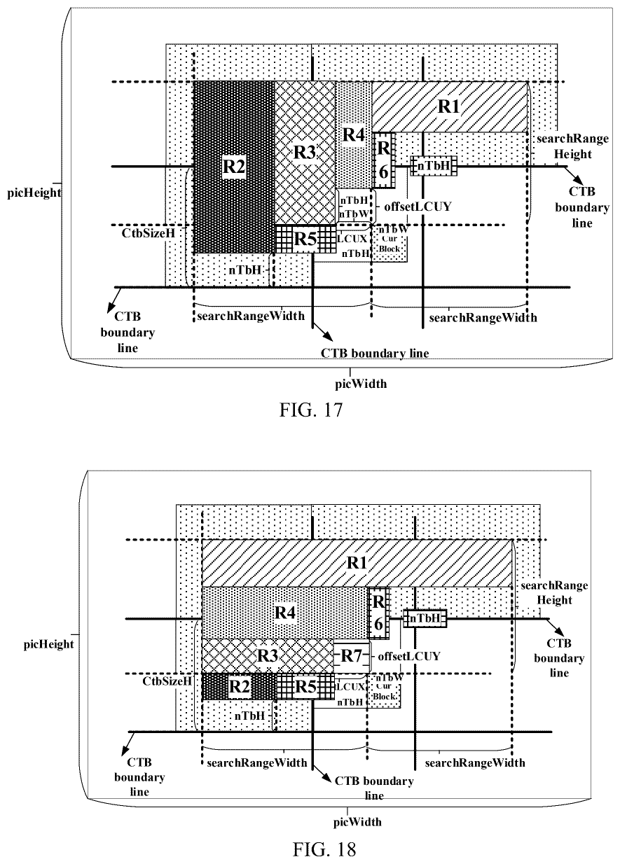

In some embodiments, based on consideration of the fully reconstructed search region and the to-be-reconstructed regin, the search region is divided into six search sub-regions, using (d) in FIG. 13 as an example. To visually describe different search sub-regions corresponding to different values of regionId, FIG. 17 is a fifth schematic diagram of a search region determining process. As shown in FIGS. 17, R1, R2, R3, R4, R5, and R6 represent six different search sub-regions, where R1, R2, R3, and R4 are fully reconstructed search regions, and R5 and R6 are to-be-determined reconstructed search regions. It should be noted that FIG. 17 shows the pixel ranges that can be aligned with the pixel in the upper left corner of a block.

That is, in some embodiments, a search region may be divided into two types, one is a type of search region in which all samples are certainly reconstructed (referred to as a fully reconstructed search region), for example, the four regions R1, R2, R3, and R4 in FIG. 17; the other one is a type of search region in which all samples are uncertainly reconstructed (referred to as a to-be-determined reconstructed search region), for example, the two regions R5 and R6 in FIG. 17.

Further, in some embodiments of this application, to implement a less quantity of search regions, so as to reduce a code amount, selective combination processing may be performed on a part of the fully reconstructed search regions and a part of the to-be-determined reconstructed search regions to form a new to-be-determined reconstructed search region, thereby reducing a quantity of search regions.

In some embodiments, combination and update processing may be performed on the fully reconstructed search regions and/or the to-be-determined reconstructed search regions to determine an updated fully reconstructed search region and an updated to-be-determined reconstructed search region. A first total region quantity of the updated fully reconstructed search regions and the updated to-be-determined reconstructed search regions is less than a second total region quantity of the fully reconstructed search regions and/or the to-be-determined reconstructed search regions.

That is, in some embodiments of this application, an initial to-be-determined reconstructed region is relatively large, and a total quantity of regions is relatively small.

For example, in some embodiments of this application, for the foregoing four full construction search regions R1, R2, R3, and R4, and two to-be-determined construction search regions R5 and R6 in FIG. 13, R2 may be combined with R5 to form a new to-be-determined construction search region. The updated fully reconstructed search regions include R1, R3, and R4, and the updated to-be-determined reconstructed search regions include R6 and the new to-be-determined reconstructed search region formed by R2 and R5.

For example, in some embodiments of this application, for the foregoing four full construction search regions R1, R2, R3, and R4, and two to-be-determined construction search regions R5 and R6 in FIG. 13, R4 may be combined with R6 to form a new to-be-determined construction search region. The updated fully reconstructed search regions include R1, R2, and R3, and the updated to-be-determined reconstructed search regions include R5 and the new to-be-determined reconstructed search region formed by R4 and R6.

Step 103: Separately search the fully reconstructed search region and/or the to-be-determined reconstructed search region and determine one or more block vectors of the current coding block.

In some embodiments of this application, after the fully reconstructed search region and/or the to-be-determined reconstructed search region are determined according to the first template, the fully reconstructed search region and/or the to-be-determined reconstructed search region may be separately searched, so as to determine one or more block vectors of the current coding block.

Further, in some embodiments of this application, when the fully reconstructed search region and/or the to-be-determined reconstructed search region are separately searched to determine one or more block vectors, in one aspect, search points in the fully reconstructed search region may be traversed, and a first matching cost value between the first template and a matching template corresponding to a search point in the fully reconstructed search region is determined according to a preset matching criterion. In another aspect, search points in the to-be-determined reconstructed search region may be traversed, and a second matching cost value between the first template and a matching template corresponding to a search point that is in the fully reconstructed search region and meets a preset condition is determined according to a preset matching criterion. Finally, one or more block vectors and one or more candidate templates corresponding to the one or more block vectors may be determined according to the first matching cost value and the second matching cost value.

That is, in some embodiments of this application, whether the sample in the to-be-determined reconstructed search region is a reconstructed sample is uncertain. Therefore, whether the sample in the to-be-determined reconstructed search region is available needs to be determined first.

It may be understood that, in some embodiments of this application, whether a current search point in a to-be-determined reconstructed search region meets a preset availability condition may be determined first. If the current search point meets the preset availability condition, it is determined, according to the preset matching criterion, the second matching cost value between the matching template corresponding to the current search point and the first template.

Correspondingly, in some embodiments of this application, after it is determined whether the current search point in the to-be-determined reconstructed search region meets the preset availability condition, if the current search point does not meet the preset availability condition, the determining of the second matching cost value is not performed.

In some embodiments, the preset availability condition includes at least one or more of the following conditions: none of samples in a matching template of a current search point exceeds a coordinate range of a sample boundary corresponding to a current image; none of samples in a reconstruction block corresponding to a matching template of a current search point exceeds a coordinate range of a sample boundary corresponding to a current image; none of samples in a matching template of a current search point exceeds a preset search window range; none of samples in a reconstruction block corresponding to a matching template of a current search point exceeds a preset search window range; all of samples in a matching template of a current search point are in a same tile as the current coding block; all of samples in a reconstruction block corresponding to a matching template of a current search point are in a same tile as the current coding block; all of samples in a matching template of a current search point have been reconstructed; none of samples in a reconstruction block corresponding to a matching template of the current search point belongs to the current coding block; or all of samples in a reconstruction block corresponding to a matching template of the current search point have been reconstructed.

It should be noted that in some embodiments of this application, the preset matching criterion includes any one of a sum of absolute difference SAD, a sum of absolute transformed difference SATD, a sum of squared error SSE, a mean absolute difference MAD, a mean absolute error MAE, a mean square error MSE, a normalized correlation coefficient NCC, or the like that is used to measure a cost of a mode.

For example, in some embodiments of this application, when determining the block vector by searching, bvYMins and bvYMaxs respectively represent a minimum offset and a maximum offset of the block vector in a vertical direction.

BvXMins_{regionId}, bvXMaxs_{regionId}, bvYMins_{regionId}, and bvYMaxs_{regionId} may be calculated by using the determined iVerMin_{regionId}, iVerMax_{regionId}, iHorMin_{regionId}, and iHorMax_{regionId} as follows:

$$bvXMinsregionId = iHorMinregionId - xTbCmp ;$$

$$bvXMaxsregionId = iHorMaxregionId - xTbCmp ;$$

$$bvYMinsregionId = iVerMinregionId - yTbCmp ;$$

$$bvYMaxsregionId = iVerMaxregionId - yTbCmp ,$$

Where bvXMins_{regionId}, bvXMaxs_{regionId}, bvYMins_{regionId}, and bvYMaxs_{regionId} defines a horizontal and vertical offset range of the search point relative to the current coding block, that is, a range of the block vector BV.

For example, in some embodiments of this application, when searching a fully reconstructed search region, one or more matching reconstruction blocks of the current coding block may be found in the reconstructed region by using a search point (iPosHor, iPox Ver) in each search region, that is, a block vector BV (each block vector BV includes a horizontal component and a vertical component: (PX, pY), where pX=iPosHor−xTbCmp, and pY=iPosVer−yTbCmp, that is, pX is between bvXMins and bvXMaxs, and pY is between bvYMins and bvYMaxs), where adjacent reconstructed pixels of the one or more matching reconstruction blocks form matching templates. Therefore, a first matching cost of the adjacent template of the current coding block and one or more adjacent templates of the reconstruction blocks may be separately calculated, and is denoted as pDiff.

Exemplarily, in some embodiments of this application, when searching a to-be-determined reconstructed search region, availability is determined for each search point iPosHor (iPosHor, iPox Ver) in each search region, that is, each block vector BV (including a horizontal component and a vertical component: (PX, pY), where pX=iPosHor−xTbCmp and pY=iPosVer−yTbCmp, pX is between bvXMins and bvXMaxs, and pY is between bvYMins and bvYMaxs). If it is determined as available, one or more matching reconstruction blocks of the current coding block may be found in the reconstructed region, and adjacent reconstructed pixels of a matching reconstruction block form a matching template. Therefore, a second matching cost of the adjacent template of the current coding block and the adjacent template of the reconstruction block may be calculated, which is also denoted as pDiff. If it is determined as not available, the template matching cost is not calculated.

Exemplarily, in some embodiments of this application, the availability determining includes but is not limited to meeting one or more of the following conditions: none of samples in a template exceeds a valid coordinate range limited by an image sample boundary; none of samples in a reconstruction block corresponding to a template exceeds a valid coordinate range limited by an image sample boundary; none of samples in a template and in a corresponding reconstruction block exceeds a range of a search window; Whether each sample in a template is in the same tile as the current encode regin; whether each sample in a reconstruction block corresponding to a template is in the same tile as a current coding regin; all of samples in a template are reconstructed; none of samples in a reconstruction block corresponding to a template is in a current coding regin; or each sample in a reconstruction block corresponding to a template has been reconstructed.

In some embodiments, the preset availability condition may further include at least one or more of the following conditions: none of first identification samples in a matching template of a current search point exceeds a coordinate range of a sample boundary corresponding to a current image; none of second identification samples in a reconstruction block corresponding to a matching template of a current search point exceeds a coordinate range of a sample boundary corresponding to a current image; none of first identification samples in a matching template of a current search point exceeds a preset search window range; none of second identification samples in a reconstruction block corresponding to a matching template of a current search point exceeds a preset search window range; all of first identification samples in a matching template of a current search point are in a same tile as the current coding block; all of second identification samples in a reconstruction block corresponding to a matching template of a current search point are in a same tile as the current coding block; all of first identification samples in a matching template of a current search point have been reconstructed; none of second identification samples in a reconstruction block corresponding to a matching template of a current search point belongs to the current coding block; or all of second identification samples in a reconstruction block corresponding to a matching template of a current search point have been reconstructed.

It should be noted that, in some embodiments of this application, the first identification samples are one or more samples in the matching template of the current search point, and the second identification samples are one or more samples in the reconstruction block corresponding to the matching template of the current search point.

That is, when determining availability of a search point in the to-be-determined reconstructed search region, the determination is not performed by traversing all samples in a matching template corresponding to the search point, but is performed by selecting an identification sample in the matching template to determine whether the search point is available. Correspondingly, the determination is not performed by traversing all samples in a reconstruction block corresponding to a matching template of the search point, but is performed by selecting an identification sample in the reconstruction block determine whether the search point is available.

It may be understood that, in some embodiments of this application, the first identification samples may be any one or more samples in a matching template. For example, the first identification samples may be one or more samples located at corner positions in a matching template, for example, when only the above template is used, the first identification samples are samples at the upper left corner and the lower right corner of the above template, or only the sample at the lower right corner.

It may be understood that, in some embodiments of this application, the second identification samples may any one or more samples in the reconstruction block corresponding to the matching template of the current search point. For example, the second identification samples may be one or more samples located at corner positions in the reconstruction block, such as samples at the upper left corner and the lower right corner of the reconstruction block, or only the sample at the lower right corner of the reconstruction block.

Further, in some embodiments of this application, when determining availability of a search point in the to-be-determined reconstructed search region, based on the preset availability condition, the first identification samples are traversed in a descending order of priority levels, and if a current first identification sample does not meet the preset availability condition, the traversing is stopped and it is determined that the current search point does not meet the preset availability condition; and if the current first identification sample meets the preset availability condition, the traversing is continued to a next first identification sample. If all the first identification samples meet the preset availability condition, it is determined that the current search point meets the preset availability condition.

Further, in some embodiments of this application, when determining availability of a search point in the to-be-determined reconstructed search region, based on the preset availability condition, the second identification samples are traversed in a descending order of priority levels, and if a current second identification sample does not meet the preset availability condition, the traversing is stopped and it is determined that the current search point does not meet the preset availability condition; and if the current second identification sample meets the preset availability condition, the traversing is continued to a next second identification sample. If all the second identification samples meet the preset availability condition, it is determined that the current search point meets the preset availability condition.

That is, in some embodiments of this application, multiple identification samples may be used in sequence. For example, it is first determined whether the sample at the upper left corner is available, and if the sample at the upper left corner is not available, a result of not available is returned. If it is available, it is determined whether the sample at the lower right corner is available. If it is not available, a result of not available is returned, and if it is available, a result of available is returned. A priority level of the sample at the upper left corner is higher than a priority level of the sample at the lower right corner.

It should be noted that, in some embodiments of this application, a quantity of block vectors determined by means of the search processing may be one or more. For example, N block vectors of the current coding block may be determined, where N is an integer greater than 0.

Correspondingly, in some embodiments of this application, when searching each of the fully reconstructed search region and/or the to-be-determined reconstructed search region to determining one or more block vectors, a preset quantity N corresponding to the candidate templates may be determined first. Then the following operations are performed: traversing search points in the fully reconstructed search region, and determining, according to a preset matching criterion, first matching cost values between the first template and matching templates corresponding to the search points in the fully reconstructed search region; and traversing search points in the to-be-determined reconstructed search region, and determining, according to the preset matching criterion, second matching cost values between the first template and matching templates corresponding to search points that meet a preset availability condition in the to-be-determined reconstructed search region. Finally, N block vectors and N candidate templates corresponding to the N block vectors may be determined according to the first matching cost values and the second matching cost values.

That is, in some embodiments of this application, when separately searching the fully reconstructed search region and/or the to-be-determined reconstructed search region and determining N block vectors corresponding to the N matching templates, that is, in a process of searching and determining the block vectors BVs corresponding to the N matching templates in the search region (the fully reconstructed search region and/or the to-be-determined reconstructed search region) may include determining a value of a quantity N of candidate templates, determining a matching template criterion, and recording N block vectors BVs corresponding to the N matching templates (the N selected candidate templates).

It may be understood that, in some embodiments of this application, when determining the preset quantity N corresponding to the candidate templates, N may be determined by decoding a bitstream. Alternatively, N may be determined according to a first preset value. Alternatively, N may be determined according to a preset value range.

That is, in some embodiments of this application, a value of N needs to be first determined, and N herein may be a preset constant, for example, N is 4. N may be in a specific value range, for example, the value of N may be any integer in [2, 8]. A value range of N may be preset. On the encoding side, the best value of N may be determined by a process of coarse selection at a cost 1, coarse selection at a cost 2, or coarse selection at a cost 3, fine selection at a cost 4, or the like, and the best value of N is transmitted to the decoding side by a bitstream. The costs 1, 2, 3, or 4 may be one of cost functions used to measure a mode, such as SAD, SATD, MSE, MAD, or RDO. A manner of determining N is not specifically limited in this application.

Further, in some embodiments of this application, when determining the N block vectors and N candidate templates corresponding to the N block vectors according to the first matching cost values and the second matching cost values, that is, when determining one or more block vectors and one or more candidate templates corresponding to the one or more block vectors, N least matching cost values among the first matching cost values and the second matching cost values may be first determined. Then, the N block vectors and the N candidate templates corresponding to the N block vectors are determined based on N search points corresponding to the N least matching cost values.

N least matching cost values among matching cost values between the first template and matching templates corresponding to search points in the fully reconstructed search region may be determined. Then the N block vectors and N candidate templates corresponding to the N least matching cost values are determined.

In some embodiments, all available search points in all search ranges (e.g., regionId=0, 1, 2, 3, 4, 5) are traversed, and N search points with least matching costs pDiff (including the first matching cost values and the second matching cost values) are obtained by comparison, and the corresponding matching costs are denoted as pDiff_BEST[n], n=0, . . . , N−1, the corresponding block vectors BVs are denoted as the best block vectors BV_BEST[n], each corresponding to a coordinate pair (pX_BEST, pY_BEST), n=0, . . . , N−1. The corresponding matching templates are the best matching templates T_BEST[n], n=0, . . . , N−1. N may be 1 or an integer value greater than 1 according to a requirement.

It may be understood that in some embodiments of this application, after the value of the quantity N of candidate templates is determined, N block vectors BV corresponding to the N matching candidate templates need to be selected according to a comparison criterion. That is, multiple block vectors BVₙ are selected and recorded. According to the block vectors BVₙ, that is, according to the template offsets pXₙ and the pYₙ, matching templates are obtained, and template matching costs are calculated, and N BVs corresponding to N matching templates with relatively small costs are recorded. Herein, the N matching templates are referred to as N candidate templates. The template matching cost (a preset matching criterion) may be one of a SAD, a SATD, an MSE, a MAD, a RDO, a correlation coefficient, or a cost function that is used to measure a mode.

Exemplarily, in some embodiments of this application, when the matching cost comparison criterion (the preset matching criterion) is a mean absolute difference (Mean Absolute Difference, MAD), a calculation formula is as follows:

$$MAD ( refT ) = \frac{1}{M} {\sum }_{m = 0}^{M - 1} \vert {refT}_{m} - {curT}_{m} \vert \qquad ( 3 )$$

Where refT is a matching template in a search process, curT is a current coding block template (the first template of the current coding block), M is a quantity of pixels of the current coding block template, and MAD (refT) is a mean absolute difference between the current coding block template curT and the found matching template.

Correspondingly, in some embodiments of this application, the MAD-based selection criterion is: comparing and recording N block vectors BVs corresponding to the N matching templates with the least MAD costs.

For example, for the N candidate templates, MADs between the n-th candidate template and the current coding block template are as follows:

$$MAD ( {refT}_{n} ) = \frac{1}{M} {\sum }_{m = 0}^{M - 1} \vert {refT}_{n , m} - {curT}_{m} \vert \qquad ( 4 )$$

Where refTₙ is a n-th candidate template, MAD (refTₙ) is the mean absolute difference between the current coding block template curT and the n-th candidate template, n=0, . . . , N−1.

Exemplarily, in some embodiments of this application, when the matching cost comparison criterion (the preset matching criterion) is the SAD, a calculation formula is as follows:

$$SAD ( refT ) = {\sum }_{m = 0}^{M - 1} \vert {refT}_{m} - {curT}_{m} \vert \qquad ( 5 )$$

Where SAD (refT) is a sum of absolute difference between the current coding block template (a first template of the current coding block) curT and a found matching template.

Correspondingly, in some embodiments of this application, the SAD-based selection criterion is: comparing and recording N block vectors BVs corresponding to N matching templates with least SAD costs.

For example, for the N candidate templates, a SAD between a n-th candidate template and the current coding block template is as follows:

$$SAD ( {refT}_{n} ) = {\sum }_{m = 0}^{M - 1} \vert {refT}_{n , m} - {curT}_{m} \vert \qquad ( 6 )$$

Where SAD (refTₙ) is a sum of absolute difference between current coding block template and the n-th candidate template.

For example, in some embodiments of this application, the NCC normalized correlation coefficient may be used as a template matching criterion, and a calculation formula is as follows:

$$R ( refT ) = \frac{{\sum }_{m = 0}^{M - 1} \vert {refT}_{m} - {refT}_{Avg} \vert * \vert {curT}_{m} - {curT}_{Avg} \vert}{\sqrt{{\sum }_{m = 0}^{M - 1} {( {refT}_{m} - {refT}_{Avg} )}^{2}} * \sqrt{{\sum }_{m = 0}^{M - 1} {( {curT}_{m} - {curT}_{Avg} )}^{2}}} \qquad ( 7 )$$

Where refT is a matching template in a search process, curT is a current coding block template (the first template of the current coding block), M is a pixel quantity of the current coding block template, refT_{Avg} is a pixel average value of a found matching template, curT_{Avg} is a pixel average value of the current coding block template, and R(refT) is a correlation coefficient between the current coding block template and the found matching template.

Correspondingly, in some embodiments of this application, a NCC-based comparison criterion is: sorting and recording N block vectors BVs corresponding to N matching templates with greatest correlation coefficients R.

For the N candidate templates, a correlation coefficient between a n-th candidate template and the current coding block template is as follows:

$$R ( {refT}_{n} ) = \frac{{\sum }_{m = 0}^{M - 1} \vert {refT}_{n , m} - {refT}_{{n}_{Avg}} \vert * \vert {curT}_{m} - {curT}_{Avg} \vert}{\sqrt{{\sum }_{m = 0}^{M - 1} {( {refT}_{n , m} - {refT}_{m} )}^{2}} * \sqrt{{\sum }_{m = 0}^{M - 1} {( {curT}_{m} - {curT}_{Avg} )}^{2}} Avg} \qquad ( 8 )$$

Where refTₙ_{_{Avg}} is a pixel average value of the n-th candidate template, and R(refTₙ) is a correlation coefficient between the current coding block template and the n-th candidate template. It should be noted that a range of the NCC normalized correlation coefficient R is [−1, 1], and a larger R indicates a stronger correlation.

It should be noted that, in some embodiments of this application, when performing search processing, a search policy that may be used may include but is not limited to a search manner based on different search step sizes. For example, a search policy may include a coarse search based on a first search step size and/or a fine search manner based on a second search step size, where the first search step size is greater than the second search step size.

In some embodiments, the first search step size and the second search step size may be any value greater than 0, and may be an integer value or may not be an integer value, provided that the first search step size is greater than the second search step size. For example, the first search step size may be 3, and the second search step size may be ½.

Further, in some embodiments of this application, the fully reconstructed search region and/or a to-be-determined reconstructed search region may be separately searched according to a first search step size, to determine first matching cost values corresponding to search points in the fully reconstructed search region and second matching cost values corresponding to search points that meet a preset availability condition in the to-be-determined reconstructed search region, and N block vectors and N candidate templates corresponding to the N block vectors are determined based on the first matching cost values and the second matching cost values.

For example, in some embodiments of this application, the coarse search may specifically include: determining a best coarse matching template in a search region by using a first preset step size (that is, the first search step size, for example, 2), to obtain a final candidate template; or determining a best coarse matching template in a search region by using a template that is downsampled (for example, a downsampling factor is 2), to obtain a final candidate template.

For example, in some embodiments of this application, if the search policy is to perform only a coarse search, in each regin, in a search rang of pX between bvXMinsregionId and bvXMaxsregionId, and pY between bvYMinsregionId and bvYMaxsregionId, a coarse search is performed at a relatively large step size (for example, by using a step size of 2 or 3), and the first N best matching costs obtained by template matching are recorded as pDiff_BEST[n], n=0, . . . , N−1, the corresponding block vectors BVs are denoted as the best block vectors BV_BEST[n], each corresponding to a coordinate pair (pX_BEST, pY_BEST), n=0, . . . , N−1. N may be 1 or an integer value greater than 1 according to a requirement. Further, in some embodiments of this application, the fully reconstructed search region and/or the to-be-determined reconstructed search region may be separately searched according to a second search step size, so as to determine first matching cost values corresponding to search points in the fully reconstructed search region and second matching cost values corresponding to search points that meet a preset availability condition in the to-be-determined reconstructed search region, and determine N block vectors and N candidate templates corresponding to the N block vectors based on the first matching cost values and the second matching cost values; where the first search step size is greater than the second search step size.

For example, in some embodiments of this application, the fine search may specifically include: determining the best fine matching template in the search region by using a second preset step size (that is, the second search step size, for example, 1), to obtain a final candidate template; or determining the best fine matching template near the best coarse matching template obtained by the coarse search, to obtain a final candidate template.

For example, in some embodiments of this application, if the search policy is to perform only a fine search, in each regin, in a search range of pX between bvXMinsregionId and bvXMaxsregionId and pY between bvYMinsregionId and bvYMaxsregionId, a fine search is performed at a relatively small step size (for example, a step is 1 or ½, and when the step is less than 1, subpixel interpolation needs to be performed), and the first N optimal matching costs obtained by template matching are recorded as pDiff_BEST[n], n=0, . . . , N−1, the corresponding block vectors BVs are denoted as the best block vectors BV_BEST[n], each corresponding to a coordinate pair (pX_BEST, pY_BEST), n=0, . . . , N−1. N may be 1 or an integer value greater than 1 according to a requirement.

Further, in some embodiments of this application, the method may include: separately searching the fully reconstructed search region and/or the to-be-determined reconstructed search region according to a first search step size, determining the first matching cost values corresponding to the search points in the fully reconstructed search region and the second matching cost values corresponding to the search points that meet the preset availability condition in the to-be-determined reconstructed search region, and determining, based on the first matching cost values and the second matching cost values, M reference block vectors and M matching reconstruction blocks corresponding to the M reference block vectors, where M is an integer greater than 0; then determining a first search region according to the M matching reconstruction blocks, where the first search region is smaller than a total region formed by the fully reconstructed search region and/or the to-be-determined reconstructed search region; then searching the first search region according to a second search step size, to determine third matching cost values between the first template and matching templates corresponding to search points that meet the preset availability condition in the first search region, wherein the first search step size is greater than the second search step size; and finally determining the N block vectors and the N candidate templates corresponding to the N block vectors according to the first matching cost values, the second matching cost values, and/or the third matching cost values.

It may be understood that, in some embodiments of this application, when determining the N block vectors and the N candidate templates corresponding to the N block vectors according to the first matching cost values, the second matching cost values, and/or the third matching cost values, N least matching cost values among the third matching cost values may be first determined. Then, the N block vectors and the N candidate templates corresponding to the N block vectors are determined based on N search points corresponding to the N least matching cost values.

It may be understood that, in some embodiments of this application, when determining the N block vectors and the N candidate templates corresponding to the N block vectors according to the first matching cost values, the second matching cost values, and/or the third matching cost values, T block vectors and T candidate templates corresponding to T block vectors may be first determined according to the third matching cost values. T is an integer greater than 0 and less than N. Based on the first matching cost values and the second matching cost values, N-T block vectors other than the M reference block vectors are determined, and N-T candidate templates corresponding to the N-T block vectors are determined.

It should be noted that, in some embodiments of this application, after coarse searching is performed, P initial block vectors based on the first matching cost values and the second matching cost values may be determined. P is an integer greater than or equal to M. Then M reference block vectors are determined according to the P initial block vectors.

For example, in some embodiments of this application, if the search policy is to perform coarse search before fine search, a coarse search may be performed at a step size of 2 (that is, the first search step size is 2) to obtain a best coarse matching template (an initial matching template), and then a best fine matching template may be determined near the best coarse matching template with a step of 1 (that is, the second search step size is 1), that is, a final candidate template is obtained.

In a coarse search stage, in each regin, a coarse search may be performed in a relatively large step size (for example, by using a step size of 2 or 3) in a search rang of pX between bvXMinsregionId and bvXMaxsregionId and pY between bvYMinsregionId and bvYMaxsregionId. For example, the first P optimal matching costs obtained by performing coarse search and template matching at a step size of 2 are denoted as pDiff1_BEST[p], p=0, . . . , P−1, the corresponding block vectors BVs are the best block vectors BV1_BEST[p], p=0, . . . , P−1. P may be 1 or an integer value greater than 1 according to a requirement, and a search region in which a best matching search point is located is bestRegionId [p], p=0, . . . , P−1. according to a requirement of the algorithm, the coarse search stage provides one or more (denoted herein as M, 1<=M<=P) fine search reference points and sends them to the next step. For example, M=1.

Next, in the fine search stage, the best block vectors BV1_BEST[p], p=0, . . . , M−1, obtained by the coarse search may be used as fine search reference points. Specifically, for each fine search reference point, a fine search range TmpRefineRangeHor and TmpRefineRangeVer is first determined. The fine search range may be of a fixed size, or may be related to a coding block size. For example, both the foregoing TmpRefineRangeHor and TmpRefineRangeVer may be set to min (nTbW, nTbH)/2, and then a position of the optimal matching reconstruction block obtained by the coarse search is used as a reference position of the fine search region: BestPosX=xTbCmp+pX1_BEST, BestPosY=yTbCmp+pY1_BEST.

In an embodiment, a search window may be directly used to directly traverse the fine search region as an entire to-be-determined reconstructed search region.

The obtaining a new search range according to the location of the best matching block obtained by the coarse search includes:

$$iHorMaxrefine = min ( picWidth - nTbW , BestPosX + TmpRefineRangeHor )$$

$$iHorMinrefine = max ( iTemplateSizeW , BestPosX - TmpRefineRangeHor )$$

$$iVerMaxrefine = min ( picHeight - nTbH , BestPosY + TmpRefineRangeVer )$$

$$iVerMinrefine = max ( iTemplateSizeH , BestPosY - TmpRefineRangeVer ) .$$

Then, the adjusted block vectors BVbvXMins, bvXMaxs, bvYMins, and bvYMaxs may be calculated by using iVerMin_{refine}, iVerMax_{refine}, iHorMin_{refine}, and iHorMax_{refine}:

$$bvXMins = iHorMinrefine - xTbCmp ;$$

$$bvXMaxs = iHorMaxrefine - xTbCmp ;$$

$$bvYMins = iVerMinrefine - yTbCmp ;$$

$$bvYMaxs = iVerMaxrefine - yTbCmp .$$

The fine search is performed in a block vector range of pX between bvXMins_{refine} and bvXMaxs_{refine} and pY between bvYMins_{refine} and bvYMaxs_{refine}, that is, all search positions in the fine search window are directly traversed for determining availability. For example, the first T best matching costs obtained by performing a search with a step size of 1 are pDiff_BEST[t], t=0, . . . , T−1, the corresponding block vectors BVs are the best block vectors BV_BEST[t], t=0, . . . , T−1. Where T is 1 or an integer greater than 1. For example, T=1.

After the foregoing operations are completed, with the results of the coarse selection process and the fine selection process (where the fine selection process includes search based on one or more reference points), one or more optimal block vectors can be obtained, as BV_BEST[n], n=0, . . . , N−1, each corresponding to a coordinate pair (pX_BEST, pY_BEST). PX_BEST and pY_BEST are respectively horizontal and vertical offsets of a best matching template relative to the current coding block template, and are also horizontal and vertical offsets of the best matching reconstruction block relative to the current coding block.

It should be noted that in some embodiments of this application, there may be different block vector selection solutions based on the results of the coarse selection process and the fine selection process. For example, the first N block vectors are selected according to sorting of all the template costs. For another example, T fine search results (obtained from the first M coarse search results) obtained by using the first M results obtained by the coarse search are followed by (N−T) results starting from the (M+1)-th results obtained by the coarse search. In some implementations, for example, M=1, T=1, N=5; or M=1, T=1, N=3.

It can be learned that, in some embodiments of this application, a process of searching and determining one or more block vectors in a search region may include three types of search policies: performing only coarse search, performing only fine search, and performing coarse search before fine search.

In some embodiments, if a search policy of coarse search before fine search is selected, after coarse search, if a search point corresponding to a reference block vector is in a fully reconstructed search region, a second search region is determined according to a matching reconstruction block corresponding to the reference block vector. The second search region is smaller than the fully reconstructed search region. Then, the second search region may be searched according to the second search step size, and third matching values between the first template and the matching template corresponding to search points in the second search region are determined.

In some embodiments, if a search policy of coarse search before fine search is selected, after coarse search, if a search point corresponding to a reference block vector is in the to-be-determined reconstructed search region, a third search region is determined according to a matching reconstruction block corresponding to the reference block vector. The third search region is smaller than a to-be-determined reconstructed search region. Then, the third search region is searched according to the second search step size, and third matching cost values between the first template and matching templates corresponding to search points that meet the preset availability condition in the third search region are determined.

That is, in an implementation process of coarse search before fine search, the following fine search solution may be used: determining, for each fine search reference point provided by the coarse search stage, a region in which the respective fine search reference point is located. For each fine search reference point, if the fine search reference point is in the fully reconstructed search region, a search process based on the fine search reference point is the same as the directly searching solution in the fully reconstructed search region. If the fine search reference point is in the to-be-determined reconstructed search region, the availability of each search point in the fine search region needs to be determined first, and the matching search and cost calculation are performed on the available points, so that one or more BVs are obtained according to the foregoing calculated costs.

In some embodiments, if a search policy of coarse search before fine search is selected, after the coarse search, the region determination may be performed on the first search region based on the reference block vectors, and a target search sub-region is determined from the fully reconstructed search region and/or the to-be-determined reconstructed search region. If the target search sub-region belongs to the fully reconstructed search region, the target search sub-region is searched according to the second search step size, and third matching cost values between the first template and matching templates corresponding to search points in the target search sub-region are determined; and if the target search sub-region belongs to the to-be-determined reconstructed search region, the target search sub-region is searched according to the second search step size, and third matching values between the first template and matching templates corresponding to search points that meet the preset availability condition in the target search sub-region are determined.

That is, in an implementation of coarse search before fine search, the fine search can be performed across regions. In the fine search stage, search is performed in a region around a block vector obtained by the coarse search, that is, the search is performed in a region around the best block vector BV1_BESTk obtained by the coarse search. Specifically, the fine search range of TmpRefineRangeHor and TmpRefineRangeVer is first determined. The fine search range may be of a fixed size, or may be related to a coding block size. For example, TmpRefineRangeHor and TmpRefineRangeVer may be set to min (nTbW, nTbH)/2, and then a position of the best matching reconstruction block obtained by the coarse search is calculated as a reference position of the fine search region: BestPosXk=xTbCmp+pX1_BESTk, BestPosYk=yTbCmp+pY1_BESTk. Further, the fine search according to each BestPosXk may be performed across multiple regions to determine a value of the bestRegionId that is involved in the calculation: for each regionId=0, 1, 2, 3, 4, 5, it is determined whether the region overlaps with the fine search region, that is, the region determination is performed. The determination may be performed by using the information of regionId of a region in which a fine search reference position provided by the coarse search is located, in combination with coordinate determination. The coordinate determination may include vertical direction determination, or horizontal direction determination, or include both vertical direction determination and horizontal direction determination.

For example, the vertical direction determination may be as follows:
If BestPosYk−TmpRefineRangeVer>=iVerMin_{regionId} and BestPosYk−TmpRefineRangeVer<=iVerMaxregionId;
or BestPosYk+TmpRefineRangeVer>=iVerMinregionId, and BestPosYk+TmpRefineRangeVer<=iVerMaxregionId,
or BestPosYk−TmpRefineRangeVer<=iVerMinregionId, and BestPosYk+TmpRefineRangeVer>=iVerMax_{regionId}.

For example, the horizontal direction is determined as follows:
If BestPosXk−TmpRefineRangeHor iHorMinregionId and BestPosXk−TmpRefineRangeHor<=iHorMaxregionId,
or BestPosYk+TmpRefineRangeHor>=iHorMinregionId, and BestPosYk+TmpRefineRangeHor<=iHorMaxregionId,
or BestPosYk−TmpRefineRangeHor<=iHorMinregionId, and BestPosYk+TmpRefineRangeHor>=iHorMaxregionId.

If a region overlaps with the fine search region, a corresponding bestSearchFlagregionId is set to 1 for the regionId. For a search region whose bestSearchFlagregionId value is 1, bestRegionId is set to regionId of this regin, and the following fine search is performed.

The determined values of iVerMinbestRegionId, iVerMaxbestRegionId, iHorMinbestRegionId, and iHorMaxbestRegionId are first obtained according to a value of bestRegionId, and then a new search range iVerMinrefine, iVerMaxrefine, iHorMinrefine, and iHorMaxrefine are obtained according to a location of the best matching block obtained by the coarse search, as follows:

$$iHorMinrefine = max ( iHorMinbestRegionId , BestPosX - TmpRefineRangeHor )$$

$$iHorMaxrefine = min ( iHorMaxbestRegionId , BestPosX + TmpRefineRangeHor )$$

$$iVerMinrefine = max ( iVerMinbestRegionId , BestPosY - TmpRefineRangeVer )$$

$$iVerMaxrefine = min ( iVerMaxbestRegionId , BestPosY + TmpRefineRangeVer )$$

Then, the adjusted block vector BVbvXMins, bvXMaxs, bvYMins, and bvYMaxs may be calculated by using iVerMinrefine, iVerMaxrefine, iHorMinrefine, and iHorMaxrefine, as follows:

$$bvXMins = iHorMinrefine - xTbCmp ;$$

$$bvXMaxs = iHorMaxrefine - xTbCmp ;$$

$$bvYMins = iVerMinrefine - yTbCmp ;$$

$$bvYMaxs = iVerMaxrefine - yTbCmp ;$$

For the fully reconstructed search region, the fine search is performed in a block vector range of pX between bvXMins_{refine} and bvXMaxs_{refine}, and pY between bvYMins_{refine} and bvYMaxs_{refine}. For example, search is performed at a step size of 1. The best matching cost obtained by template matching is recorded as pDiff_BEST, and a block vector BV corresponding to the pDiff_BEST is denoted as a best block vector BV_BEST (pX_BEST, pY_BEST).

For a to-be-determined reconstructed search region, a fine search is performed in a block vector range of pX between bvXMins_{refine} and bvXMaxs_{refine}, and pY between bvYMins_{refine} and bvYMaxs_{refine}, and availability of each point is determined. For example, search is performed at a step size of 1, and the best matching cost obtained by performing template matching on available points is denoted as pDiff_BEST, and a block vector BV corresponding to the pDiff_BEST is denoted as a best block vector BV_BEST (pX_BEST, pY_BEST).

Finally, a final best block vector of multiple regions that participate in the search may be obtained. That is, after the foregoing operations are completed, the best block vector BV_BEST (pX_BEST, pY_BEST) may be obtained, where pX_BEST and pY_BEST are respectively a horizontal direction offset and a vertical direction offset of the best matching template relative to the current coding block template, and are also a horizontal direction offset and a vertical direction offset of the best matching reconstruction block relative to the current coding block.

In some embodiments, if a search policy of coarse search before fine search is selected, when performing coarse search, a search may be performed in the fully reconstructed search region according to a first search step size, first matching cost values corresponding to search points in the fully reconstructed search region are determined, and M reference block vectors and M matching reconstruction blocks corresponding to the M reference block vectors are determined based on the first matching cost values.

That is, in an implementation process of coarse search before fine search, in the coarse search stage, search may be performed only in the fully reconstructed search region, without performing a coarse search in the to-be-determined reconstructed search region (for example, a to-be-determined reconstructed search region corresponding to R5 and R6), and the to-be-determined reconstructed search region is searched only in the fine search stage, that is, the M reference block vector are obtained by performing the coarse search in the fully reconstructed search region.

In some embodiments, if a search policy of coarse search before fine search is selected, when performing the coarse search, the fully reconstructed search region and a part of the to-be-determined reconstructed search region may be separately searched according to the first search step size. The first matching cost values corresponding to the search points in the fully reconstructed search region and the second matching cost values corresponding to search points that meet the preset availability condition in the part of the to-be-determined reconstructed search region are determined. Based on the first matching cost values and the second matching cost values, the M reference block vectors and the M matching reconstruction blocks corresponding to the M reference block vectors are determined.

That is, in an implementation process of coarse search before fine search, in the coarse search stage, search may be performed in the fully reconstructed search region and in a part of the to-be-determined reconstructed search regions (for example, a to-be-determined reconstructed search region corresponding to R5 or R6), instead of in all the to-be-determined reconstructed search region. That is, the M reference block vectors are obtained by performing a coarse search in the fully reconstructed search region and a part of the to-be-determined reconstructed search region.

Further, in some embodiments of this application, in a process of searching a block vector, a combination and update processing may be performed on the fully reconstructed search region and/or the to-be-determined reconstructed search region, to determine an updated fully reconstructed search region and an updated to-be-determined reconstructed search region. The quantity of the updated fully reconstructed search region and the updated first total region of the to-be-determined reconstructed search region is less than the quantity of the fully reconstructed search region and/or the second total region of the to-be-determined reconstructed search region. Then search points in the updated fully reconstructed search region are traversed, to determine, according to a preset matching criterion, first matching cost values between the first template and matching templates corresponding to search points in the updated fully reconstructed search region. The search points in the updated to-be-determined reconstructed search region are also traversed, to determine, according to a preset matching criterion, second matching cost values between the first template and matching templates corresponding to search points that meet a preset availability condition in the updated to-be-determined reconstructed search region. Finally, one or more block vectors and one or more candidate templates corresponding to the one or more block vectors may be determined according to the first matching cost values and the second matching cost values.

That is, in some embodiments of this application, after selective combination processing is performed on some fully reconstructed search regions and some to-be-determined reconstructed search regions to form a new to-be-determined reconstructed search region, an updated fully reconstructed search region and an updated to-be-determined reconstructed search region are obtained, which may be separately searched. For search points in the updated to-be-determined reconstructed search region, availability needs to be first determined, and then second matching cost values between the first template and matching templates corresponding to searching points that meet a preset availability condition in the updated to-be-determined reconstructed search region are determined, and further one or more block vectors and one or more candidate templates corresponding to the one or more block vectors are determined.

Further, in some embodiments of this application, search points in the to-be-determined reconstructed search region may be traversed to determine search points that meet a preset availability condition in the to-be-determined reconstructed search region. Boundary adjustment is performed on the to-be-determined reconstructed search region based on the search points that meet the preset availability condition in the to-be-determined reconstructed search region, to determine an adjusted search region, where all samples in the adjusted search region have been reconstructed. Search is performed in the fully reconstructed search region and the adjusted search region to determine one or more block vectors of the current coding block.

That is, in some embodiments, for the to-be-determined reconstructed search region, the boundary of the to-be-determined reconstructed search region may be further modified by determining availability of each position in advance, so that the to-be-determined reconstructed search region becomes a fully reconstructed search region, that is, a boundary adjustment may be performed by using search points that meet a preset availability condition in the to-be-determined reconstructed search region, so that all samples in the adjusted search region are reconstructed samples, that is, the adjusted search region is a fully reconstructed search region in which all points are available.

Further, in some embodiments of this application, the to-be-determined reconstructed search region may be first determined according to a preset search range window. Then search points in the to-be-determined reconstructed search region are traversed, to determine, according to a preset matching criterion, fourth matching cost values between the first template and matching templates corresponding to search points that meet a preset availability condition in the to-be-determined reconstructed search region. Further, one or more block vectors and one or more candidate templates corresponding to the one or more block vectors may be determined according to the fourth matching cost values.

In some embodiments, a preset search range window may be used to determine a search region. For example, the entire search range window may be directly determined as a search region to be searched. Based on the foregoing FIG. 6, the whole regin in a dotted line block may be directly used as a to-be-determined reconstructed search region, to be directly traversed. The process is as follows.

For each search position in the dotted line block in FIG. 6:
iHorMax=min((xTbCmp+searchRange Width)<<iBvShift, ((picWidth−nTbW)<<iBvShift))
iHorMin=max((iTemplateSizeW)<<iBvShift, (xTbCmp−searchRangeWidth)<<iBvShift)
iVerMax=min((yTbCmp+searchRangeHeight)<<iBvShift, ((picHeight−nTbH)<<iBvShift))
iVerMin=max(((iTemplateSizeH)<<iBvShift), ((yTbCmp−searchRangeHeight)<<iBvShift))

For each search position (iPosHor, iPox Ver), that is, each block vector BV (including a horizontal component and a vertical component: (pX, pY), where pX=iPosHor-xTbCmp and pY=iPosVer−yTbCmp, pX is between bvXMins and bvXMaxs, and pY is between bvYMins and bvYMaxs), the availability determination is performed. If determined as available, a matching reconstruction block of the current coding block is found in the reconstructed region, and adjacent reconstructed pixels of the reconstruction block form a matching template. Therefore, the matching cost (that is, the fourth matching cost value) of the current coding block adjacent template and the reconstruction block adjacent template can be calculated, which is denoted as pDiff.

A search point with a least matching cost (the fourth matching cost value) pDiff is obtained in a traversing and comparing process. The corresponding matching cost is denoted as pDiff_BEST, a corresponding block vector BV is denoted as a best block vector BV_BEST (pX_BEST, pY_BEST), and a corresponding matching template is denoted as a best matching template T_BEST.

In some embodiments, a preset search range window may be used to determine the search region. For example, when determining the to-be-determined reconstructed search region according to the preset search range window, the to-be-determined reconstructed search region may be determined according to the preset search range window and a location of a current encoding tree block corresponding to the current coding block.

That is, in some embodiments of this application, if all search positions in the dotted line block in FIG. 6 are used, a lower limit of the search range may be changed to a lower edge of the current CTU, that is, iVerMax=min((picHeight−nTbH)<<iBvShift, (yTbCmp−offsetLCBY+CtbSizeH−nTbH)<<iBvShift) is set, so that a to-be-determined reconstructed search region is determined.

Further, in some embodiments of this application, after one or more block vectors corresponding to the current coding block are determined, one or more reference blocks of the current coding block may be further determined according to the one or more block vectors, and then a predicted value of the current coding block may be determined according to the one or more reference blocks.

It may be understood that, in some embodiments of this application, in a case in which an overlapping regin exists between a reference block and the current coding block, a repetitive padding process may be performed for determining a predicted value of the current coding block.

In some embodiments, based on consideration of the fully reconstructed search region and the to-be-reconstructed regin, a search region is divided into seven search sub-regions, using (a) in FIG. 13 as an example. An implementation manner thereof is as follows:

When regionId is equal to 0, iVerMin, iVerMax, iHorMin, and iHorMax may be calculated as follows:

$$iHorMax = min ( ( xTbCmp + searchRangeWidth ) << iBvShift , ( ( picWidth - nTbW ) << iBvShift ) )$$

$$iHorMin = max ( ( iTemplateSizeW ) << iBvShift , ( ( xTbCmp + searchRangeWidth ) << iBvShift ) )$$

$$iVerMax = ( ( yTbCmp - nTbH - offsetLCBY ) << iBvShift$$

$$iVerMin = max ( ( iTemplateSizeH ) << iBvShift ) , ( ( yTbCmp - searchRangeHeight ) << iBvShift ) )$$

When regionId is equal to 1, iVerMin, iVerMax, iHorMin, and iHorMax may be calculated as follows:

$$iHorMin = max ( ( iTemplateSizeW ) << iBvShift , ( ( xTbCmp + searchRangeWidth ) << iBvShift )$$

$$iHorMax = min ( xTbCmp - offsetLCBX - nTbW ) << iBvShift ;$$

$$iVerMin = ( ( yTbCmp + 1 ) << iBvShift ;$$

$$iVerMax = min ( picHeight - nTbH , ( yTbCmp - offsetLCBY + CtbSizeH - nTbH ) << iBvShift )$$

When regionId is equal to 2, iVerMin, iVerMax, iHorMin, and iHorMax may be calculated as follows:

$$iHorMax = ( xTbCmp - nTbW ) << iBvShift ;$$

$$iHorMin = max ( ( iTemplateSizeW ) << iBvShift , ( xTbCmp + searchRangeWidth ) << iBvShift ) ;$$

$$iVerMin = max ( ( iTemplateSizeH ) << iBvShift , ( yTbCmp - nTbH ) << iBvShift ) ;$$

$$iVerMax = min ( yTbCmp ) << iBvShift ;$$

When regionId is equal to 3, iVerMin, iVerMax, iHorMin, and iHorMax may be calculated as follows:

$$iHorMin = max ( ( iTemplateSizeW ) << iBvShift , ( ( xTbCmp + searchRangeWidth ) << iBvShift ) ;$$

$$iHorMax = ( xTbCmp ) << iBvShift ;$$

$$iVerMin = max ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift ;$$

When regionId is equal to 4, iVerMin, iVerMax, iHorMin, and iHorMax may be calculated as follows:

$$iHorMin = ( xTbCmp - offsetLCBY - nTbW ) << iBvShift ;$$

$$iHorMax = ( xTbCmp - nTbW ) << iBvShift ;$$

$$iVerMin = ( yTbCmp + 1 ) << iBvShift ;$$

$$iVerMax = min ( picHeight - nTbH , ( yTbCmp - offsetLCBY + CtbSizeH - nTbH ) << iBvShift )$$

When regionId is equal to 5, iVerMin, iVerMax, iHorMin and iHorMax may be calculated as follows:

$$iHorMin = ( xTbCmp + CtbSizeW - nTbW ) << iBvShift , min ( ( xTbCmp + searchRangeWidth ) << iBvShift , ( ( picWidth - nTbW ) << iBvShift ) ) ) ;$$

$$iHorMax = min ( ( xTbCmp + ) << iBvShift , ( ( xTbCmp + searchRangeWidth ) << iBvShift ) ) ;$$

$$iVerMin = max ( ( iTemplateSizeH ) << iBvShift ) , ( yTbCmp - offsetLCBY - nTbH + 1 ) << iBvShift ) ;$$

$$iVerMax = ( yTbCmp - nTbH ) << iBvShift ;$$

When regionId is equal to 6, iVerMin, iVerMax, iHorMin, and iHorMax may be calculated as follows:

$$iHorMax = ( xTbCmp + ) << iBvShift ;$$

$$iHorMin = ( xTbCmp - nTbW ) << iBvShift ;$$

$$iVerMin = max ( ( iTemplateSizeH ) << iBvShift , ( yTbCmp - nTbH ) << iBvShift ) ;$$

$$iVerMax = ( yTbCmp ) << iBvShift .$$

In actual application, iHorMinregionId, iHorMaxregionId, iVerMinregionId, and iVerMaxregionId herein respectively represent left edge, right edge, upper edge, and lower edge of different search sub-regions.

To intuitively describe different search sub-regions corresponding to different values of regionId, FIG. 18 is a six schematic diagram of a determining process of the search region. As shown in FIGS. 18, R1, R2, R3, R4, R5, R6, and R7 indicate seven different search sub-regions, where R1, R2, R3, R4, and R7 are fully reconstructed search regions, and R5 and R6 are to-be-determined reconstructed search regions. It should be noted that FIG. 18 shows the pixel ranges that can be aligned with the pixel in the upper left corner of a block.

It should be noted that, in some embodiments of this application, for a search region R7, that is, when regionId is equal to 6, a search point at a lower right corner of R7 is omitted in a search process, because the point overlaps with an upper left corner of the current coding block.

For example, in this application, when determining a predicted value of the current coding block, for R1 to R6 that do not have an overlapping regin with the current coding block, simple translation and replication may be performed. A specific operation is as follows:
for x=0 . . . nTbW−1, y=0 . . . nTbH−1,

$$PredSamp les [ x ] [ y ] = recSamples [ x + pX\_BEST ] [ y + pY\_BEST ]$$

Where recSamples represents a reconstructed pixel of the current frame.

For example, in an embodiment of this application, when determining a predicted value of the current coding block, for R7 that has an overlapping regin with the current coding block, repetitive padding may be performed. A BV in this regin complies with pX_BEST=−nTbW+1 . . . 0, pY_BEST=−nTbH+1 . . . 0, and pX_BEST and pY_BEST are not 0 at the same time. A specific operation is as follows:
for x=0 . . . pX_BEST−1, y=0 . . . pY_BEST−1,

$$predSamp les [ x ] [ y ] = recSamples [ x + pX\_BEST ] [ y + pY\_BEST ]$$

where recSamples represents a reconstructed pixel of a current frame;
for x=pX_BEST−1 . . . nTbW−1, y=pY_BEST−1 . . . nTbH−1,

$$predSamples [ x ] [ y ] = predSamples [ x + pX\_BEST ] [ y + pY\_BEST ] .$$

It can be learned that in some embodiments of this application, the determining the predicted value of the current coding block according to the one or more reference blocks may include: if the current coding block comprises a first sample overlapping with the reference blocks, determining, according to the block vectors, a reference point corresponding to the first sample and a reference point corresponding to a second sample, wherein the second sample is a sample that is in the current coding block and is other than the first sample; determining a predicted pixel of the first sample according to a predicted pixel of the reference point corresponding to the first sample, and determining a predicted pixel of the second sample according to a reconstructed pixel of the reference point corresponding to the second sample; and determining the predicted value of the current coding block according to the predicted pixel of the first sample and the predicted pixel of the second sample.

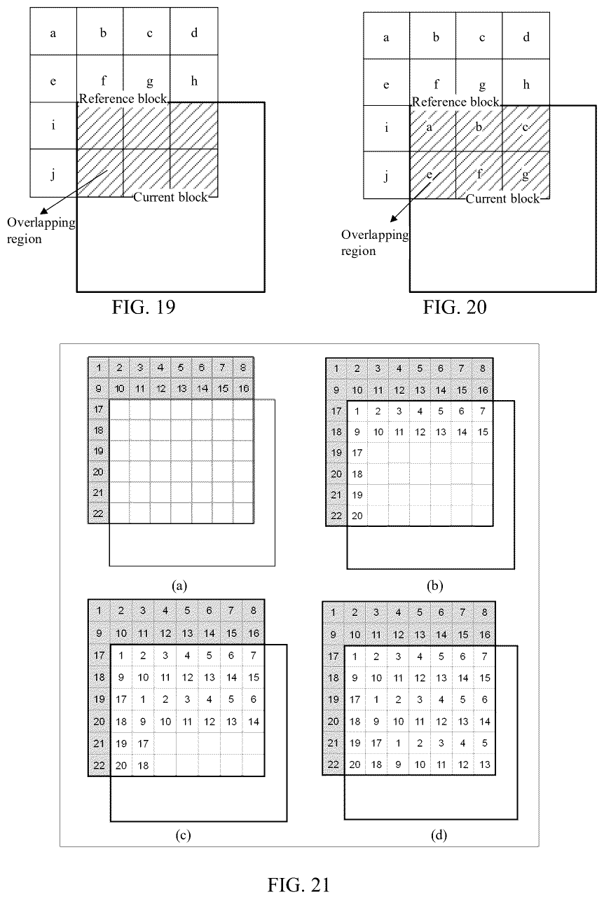

FIG. 19 is a schematic diagram of a case in which an overlapping regin exists. As shown in FIG. 19, when a first sample in the upper left region of the current coding block overlaps the reference block, for a second sample in an unoverlapping regin (that is, for x=0 . . . pX_BEST−1, y=0 . . . pY_BEST−1), a predicted pixel of the second sample may be determined by using a reconstructed pixel of a reference point corresponding to the second sample, that is, predSamples[x][y]=recSamples [x+pX_BEST][y+pY_BEST], and for the first sample (x=pX_BEST−1 . . . nTbW−1, y=pY_BEST−1 . . . nTbH−1) in the overlapping regin, a predicted pixel of the first sample may be determined by using a predicted pixel of a reference point corresponding to the first sample, that is, predSamples[x][y]=predSamples[x+pX_BEST][y+pY_BEST], so that a reference value corresponding to the current coding block can be finally obtained.

For example, in another embodiment of this application, when determining a predicted value of the current coding block, for R7 that has an overlapping regin with the current coding block, repetitive padding may be performed. A BV in this regin complies with pX_BEST=−nTbW+1 . . . 0, pY_BEST=−nTbH+1 . . . 0, and pX_BEST and pY_BEST are not 0 at the same time. A specific operation is as follows:
first, for x=pX_BEST−1 . . . nTbW−1, y=pY_BEST−1 . . . nTbH−1

$$recSamples ‘ [ x ] [ y ] = recSamples [ x + pX\_BEST ] [ y + pY\_BEST ] ;$$

for x=0 . . . pX_BEST−1, y=0 . . . pY_BEST−1,

$$recSamples ‘ [ x ] [ y ] = recSamples [ x ] [ y ] ;$$

then for x=0 . . . nTbW−1, y=0 . . . nTbH−1,

$$predSample s [ x ] [ y ] = recSamples ‘ [ x + pX\_BEST ] [ y + pY\_BEST ] .$$

It can be learned that, in some embodiments of this application, the determining the predicted value of the current coding block according to the one or more reference block may include: if the reference blocks comprise a third sample overlapping with the current coding block, determining, according to the block vectors, a reference point corresponding to the third sample; determining a reconstructed pixel of the reference point as a reconstructed pixel of the third sample; and determining a predicted value of the current coding block according to the reconstructed pixel of the third sample and a reconstructed pixel of a fourth sample in the reference blocks, where the fourth sample is a sample that is in the reference blocks and is other than the third sample.

Based on the foregoing FIG. 19, FIG. 20 is a schematic diagram of a manner of determining a predicted value in a case in which an overlapping regin exists. As shown in FIG. 20, when a third sample in a lower right region of the reference block overlaps the current coding block, a reconstructed pixel of the third sample may be determined by using a reconstructed pixel of a reference point corresponding to the third sample, that is, recSamples' [x][y]=recSamples [x+pX_BEST][y+pY_BEST]. For a fourth sample in an unoverlapping regin (that is, for x=0 . . . pX_BEST−1, y=0 . . . pY_BEST−1), a reconstructed pixel of the fourth sample may be determined by using a reconstructed pixel of the fourth sample, that is, recSamples'[x][y]=recSamples [x][y]. Finally, reconstructed pixels of the entire reference block may be directly copied to the current coding block, that is, for x=0 . . . nTbW−1, y=0 . . . nTbH−1, predSamples[x][y]=recSamples'[x+pX_BEST][y+pY_BEST], thereby obtaining a reference value corresponding to the current coding block.

It may be understood that, in some embodiments of this application, after the search region division is performed, there may be one or more search regions that overlap with the current coding block, such as R7. For these search regions that overlap with the current coding block, a predicted value corresponding to the BV of the regin may be obtained by repetitive padding.

It may be understood that in some embodiments of this application, when determining a predicted value of the current coding block, if overlapping samples exist between the current coding block and a reference block, one or more padding may be performed by traversing the overlapping samples according to the block vector.

That is, in some embodiments of this application, for example, for one or more search regions overlapping with the current coding block, such as R7, the padding may be performed for multiple times.

Exemplarily, in some embodiments of this application, FIG. 21 is a schematic diagram of implementation of repetitive padding. As shown in FIG. 21, it is assumed that a block vector BV is (−1,−2). For a 8×8 reference block (as shown in (a)) corresponding to the block vector, repetitive padding may be performed on samples of an overlapping regin. For example, after first padding is performed according to the block vector BV (−1,−2), a padding result is as shown in (b). Then, a second padding and a third padding may be performed according to the block vector BV (−1,−2), to obtain the padding result as shown in (c) and (d), to finally obtain reconstructed pixels of an entire reference block. Then the entire reference block shown in (d) is copied to the current coding block as a predicted value of the current coding block.

It should be noted that, in some embodiments of this application, the predicted value determined according to the one or more block vectors may be a final predicted value of the current coding block that is used to determine the reconstructed value, or may be processed by a series of corresponding processing to obtain the final predicted value of the current coding block. This is not specifically limited in this application.

It should be noted that in some embodiments of this application, one or more reference blocks of the current coding block includes a first reference block and/or a second reference block. Both the first reference block and the current coding block belong to the current image, and the second reference block belongs to a reference image of the current image corresponding to the current coding block.

That is, in some embodiments of this application, the one or more reference blocks of the current coding block may include a first reference block in a current image obtained by intra prediction, or may include a second reference block in a reference image of the current image obtained by inter prediction, or may include both a first reference block in a current image obtained by intra prediction and a second reference block in a reference image of the current image obtained by inter prediction.

Correspondingly, in some embodiments of this application, when obtaining the second reference block, one or more block vectors may be determined by decoding a bitstream. Then, the reference image of the current image may be searched to determine the second reference block corresponding to the one or more block vectors.

That is, in some embodiments of this application, the template matching search may be performed on the current image in an intra-frame template matching manner to determine one or more reference blocks corresponding to the current coding block, that is, the first reference block. The template matching search may also be performed on the one or more inter-frame reference image of the current image in an inter-frame template matching manner to determine one or more reference blocks corresponding to the current coding block, that is, the second reference block. The template matching search may be separately performed on the current image and the one or more inter-frame reference image in the intra-frame template matching manner and the inter-frame template matching manner, to determine one or more reference blocks corresponding to the current coding block, including the first reference block and the second reference block.

Further, in some embodiments of this application, when determining the one or more reference blocks corresponding to the current coding block according to the one or more block vectors, one or more initial reconstruction blocks corresponding to the current coding block may be first determined according to the one or more block vectors. Then, correction processing may be performed on the one or more initial reconstruction blocks to determine the one or more reference blocks.

That is, in some embodiments of this application, the N candidate reconstruction blocks (reference blocks) may be obtained in another manner. For example, an initial reconstruction block corresponding to an obtained candidate template is first corrected, and then a corresponding reference block is determined.

Correspondingly, after N candidate reconstruction blocks (reference blocks) are obtained by copying matching reconstruction blocks (initial reconstruction blocks) corresponding to N BVs, the N candidate reconstruction blocks may be directly weighted to obtain a predicted value of the current coding block. Alternatively, the candidate reconstruction blocks (reference blocks) may be obtained by correcting the matching reconstruction blocks (initial reconstruction blocks) corresponding to the N BVs, and then are weighted to obtain a predicted value of the current coding block.

Further, in some embodiments of this application, when correcting the one or more initial reconstruction blocks to determine the one or more reference blocks, filtering processing may be performed on the one or more initial reconstruction blocks to determine the one or more reference blocks.

Further, in some embodiments of this application, when correcting the one or more initial reconstruction blocks to determine the one or more reference blocks, one or more correction parameter vectors may be first determined according to one or more candidate templates corresponding to the one or more block vectors, and then correction processing is performed on the one or more initial reconstruction blocks according to the one or more correction parameter vectors to determine the one or more reference blocks.

Further, in some embodiments of this application, when determining the one or more correction parameter vectors according to the one or more candidate templates corresponding to the one or more block vectors, an autocorrelation matrix corresponding to a candidate template may be first determined according to pixel values in the candidate template. Then a cross-correlation vector is determined according to pixel values in the first template and pixel values in the candidate template. Further, a correction parameter vector is determined according to the autocorrelation matrix and the cross-correlation vector.

It may be understood that, in some embodiments of this application, the solution for correcting the initial reconstruction block may include directly performing filtering processing on the initial reconstruction block. A used filtering solution may be a conventional filtering method, such as bilateral filtering or mean filtering, or neural network-based filtering enhancement.

It may be understood that, in some embodiments of this application, the solution of correcting the initial reconstruction block may further include: correcting the matching reconstruction block (initial reconstruction block) by using matching template information (a candidate template).

For example, in some embodiments of this application, when correcting the matching reconstruction block by using the matching template information, for each candidate template refTₙ and a corresponding candidate reconstruction block (initial reconstruction block) RefBlockₙ, a correction parameter vector Cn is calculated by using the candidate template refTₙ and the current coding block template (the first template of the current coding block) curT, and weighted fusion is performed on the correction parameter vector Cn and the candidate reconstruction block RefBlockₙ to obtain a finally corrected reconstruction block RefBlock′ₙ, that is, the finally obtained reference block of the current coding block is RefBlock′ₙ.

In some embodiments, the correction parameter vector Cn may be derived by minimizing the MSE between the reconstruction values of the candidate template refTₙ and the pixel values of the template to be predicted.

It may be understood that, in some embodiments of this application, the correction parameter vector Cn may be considered as an L-tap filter.

In some embodiments, when calculating the correction parameter vector Cn, for each candidate template refTₙ, n=0, 1 . . . , N, the process of minimizing MSE takes the autocorrelation matrix of the candidate template sample refT, and the cross-correlation vector of the candidate template sample refT and the current coding block adjacent template sample curT as inputs to output the weight of the candidate reconstruction block corresponding to the current candidate template.

It should be noted that in some embodiments of this application, after N block vectors BVs corresponding to the N candidate templates of the current coding block are determined, N candidate reconstruction blocks (that is, N reference blocks) may be obtained by using the N BVs, and then weighted fusion is performed on the N candidate reconstruction blocks to obtain a prediction block of the current coding block (that is, a predicted value of the current coding block). When generating the final predicted value, N candidate reconstruction blocks (N reference blocks) may be first obtained, corresponding weights (weight values) for weighted fusion are determined, and then weighted fusion processing is performed to generate the predicted value of the current coding block.

It may be understood that, in some embodiments of this application, when determining the one or more reference blocks of the current coding block according to the one or more block vectors, for N block vectors BVₙ corresponding to the N obtained candidate templates, N candidate reconstruction blocks (that is, reference block) RefBlockₙ are directly obtained from the current image and/or the reference image according to the BVn, where a horizontal offset of the BVₙ is pXₙ, and a vertical offset of the BVₙ is pYₙ, where n=0.1 . . . , N−1.

For example, in some embodiments of this application, when determining one or more reference blocks in the current coding block, simple translation and replication may be used. A specific operation is as follows: for x=0 . . . nTbW−1, y=0 . . . nTbH−1, the reconstructed pixels of the current frame (that is, the reference block of the current coding block) are determined by using RefBlockₙ[x][y]=recSamples[x+pXₙ][y+pYₙ].

Further, in some embodiments of this application, when determining the predicted value of the current coding block according to the one or more reference blocks, one or more weight values corresponding to the one or more reference blocks may be first determined. Then, weighted fusion is performed on the one or more reference blocks according to the one or more weight values, to finally determine a predicted value of the current coding block.

It should be noted that in some embodiments of this application, after the N candidate reconstruction blocks RefBlock (that is, the reference blocks of the current coding block) are obtained, weights W used for weighted fusion of the N candidate reconstruction blocks need to be calculated. The weight values corresponding to the reference blocks may be determined in multiple manners. For example, the weight may be of a predefined determined value (such as a second preset value), or may be obtained by adaptive calculation using a cost value, a pixel value, or the like.

In an embodiment, one or more weight values may be determined according to a second preset value. The second preset value may include N values greater than 0. For different reference blocks of the N reference block, corresponding weight values may be the same, or may be different, which is not specifically limited in this application.

In an embodiment, the one or more weight values may be determined according to the one or more candidate templates corresponding to the one or more block vectors. When determining the one or more weight values according to the one or more candidate templates corresponding to one or more block vectors, an autocorrelation matrix corresponding to a candidate template may be first determined according to pixel values in the candidate template. Then, a cross-correlation vector may be determined according to pixel values in the first template and the pixel values in the candidate template. Further, the weight value may be determined according to the autocorrelation matrix and the cross-correlation vector.

In some embodiments, the weight (weight value) for weighted fusion may be derived by minimizing the MSE using the reconstructed values of the candidate template refTₙ and the pixel values of the template to be predicted (the first template) refpredTₙ.

It should be noted that, to make the weight derivation process more flexible, a non-linear term and an offset term may be added to a process of deriving the weighted fusion weight.

For example, in some embodiments of this application, when deriving the weighted fusion weight, the nonlinear term NonLinearTerm_T is constructed based on a candidate template. A candidate template whose sequence number is 0 may be selected from the N candidate templates for the construction.

For example, in some embodiments of this application, for each candidate reconstruction block (reference block) corresponding to the N candidate templates, when applying a weight for weighted fusion, the nonlinear term NonLinearTerm_Block is constructed based on the candidate reconstruction block. The candidate reconstruction block corresponding to the candidate template whose sequence number is 0 may be selected.

The offset value Bias in the process of deriving weights and applying weights may be any constant in the image pixel range [0, (1<<bitDepth)−1], for example, Bias may be set to 1<<(bitDepth−1).

Because BiasTerm is a constant, in an actual calculation process, BiasTerm needs to be extended to a BiasTerm matrix.

It may be understood that, in some embodiments of this application, after the non-linear term and the offset term are added, N+2 weights (weight values) need to be derived. For ease of description, a variable P is used to record a weight quantity, where P=N+2, and a matching template sample, a non-linear term sample and an offset term sample are collectively referred to as matching reference samples refT_{N} and refT_{N+1}. Therefore, all reference quantities involved in calculation may be uniformly represented as refTₚ. Similarly, the reconstruction block corresponding to the matching template, the reconstruction block corresponding to the matching template involved in the non-linear item, and the offset item are collectively referred to as candidate reconstruction samples refBlockₚ, where p=0, 1 . . . , and P−1.

For example, in some embodiments of this application, in a process of minimizing an MSE, autocorrelation matrixes of the first P matching reference samples refT, cross-correlation vectors of the first P matching reference samples refT and a current coding block adjacent template samples curT are used as inputs, and weights of reconstruction blocks corresponding to the matching reference items are output.

In an embodiment, when determining one or more weight values according to the one or more candidate templates corresponding to the one or more block vectors, matching cost values between the first template and the candidate templates may be first determined. Then, the weight values are determined according to the matching cost values.

Further, in some embodiments of this application, the weights may also be calculated in another manner. For example, a weight wₙ may be allocated to a corresponding candidate reconstruction block (reference block) RefBlockₙ by using a nonlinear weight model according to costs of N matched candidate templates.

It should be noted that, in some embodiments of this application, the weight model may include but is not limited to a non-linear normalization function, a non-linear index normalization function, and the like.

Exemplarily, in some embodiments of this application, a weight of each candidate reconstruction block (reference block) may be calculated by using the following nonlinear function, where input of the weight model is a matching cost between the current coding block template curT and the candidate template refTₙ, and the matching cost includes but is not limited to SAD (refTₙ), MAD (refTₙ), and correlation coefficient R(refTₙ) between the current coding block template curT and the candidate template refTₙ.

In some embodiments, when deriving the weights (weight values) for weighted fusion by minimizing the MSE using the reconstructed values of the candidate template refTₙ and the pixel values of the template to be predicted (the first template) refpredTₙ, the nonlinear term and the offset term may not be added.

Exemplarily, in the embodiment of the application, if the non-linear term and the offset term are not added, only N weights (weight values) need to be derived. In a process of minimizing the MSE, the autocorrelation matrixes of the first N candidate template samples refT, the cross-correlation vectors of the first P candidate template samples refT and the current coding block adjacent template sample curT are used as inputs, and weights of candidate reconstruction blocks corresponding to the candidate templates are output.

Exemplarily, in this embodiment of the present application, if only an offset item is added, and no non-linear item is added, N+1 weights (weight values) need to be derived. For ease of description, a variable P is used to record a quantity of weights, where P=N+1, and candidate template sampled are the offset item sample are collectively referred to as a matching reference sample refT_{N} and refT_{N+1}. Therefore, all reference quantities involved in the calculation may be uniformly represented as refTₚ. Similarly, a candidate reconstruction block corresponding to the candidate template and an offset are collectively referred to as candidate reconstruction samples refBlockₚ, where p=0, 1 . . . , and P−1.

In some embodiments, the MSE minimization process uses the autocorrelation matrixes of the first P matched reference samples refT, the cross-correlation vectors of the first P matched reference samples refT and the current coding block adjacent template sample curT as inputs to output the weights of the reconstructed blocks corresponding to the matching reference term.

Further, in some embodiments of this application, after the one or more reference blocks of the current coding block are determined according to the one or more block vectors, and the predicted value of the current coding block is determined according to the one or more reference blocks, a reconstructed value of the current coding block may be further determined according to the predicted value of the current coding block.

It should be noted that in some embodiments of this application, the prediction residual (residual) corresponding to the current coding block may be determined by decoding a bitstream. Then, the reconstructed value of the current coding block may be further determined according to the prediction residual and the predicted value.

In conclusion, the proposed decoding method of step 101 to step 103 improves and optimizes a common Intra TMP technology. In the prediction process of the Intra TMP, a to-be-determined reconstructed search region and/or a fully reconstructed search region are determined, and availability determination of each search position is added to a traversing process of the to-be-determined reconstructed search region, thereby fully utilizing information about all adjacent reconstructed samples.

Inputs of the Intra TMP-BV obtaining are a location (xTbCmp, yTbCmp) of the current coding block (current coding block), a width nTbW of the current coding block, and a height nTbH of the current coding block. Outputs of the Intra TMP-BV obtaining are one or more BVs of the current coding block and corresponding prediction block predicted values of predSamples[x][y], where x=0 . . . nTbW−1, y=0 . . . nTbH−1. The prediction block predicted values may be used as a final predicted value, or may be further processed to obtain a final predicted value of the current coding block.

It may be understood that a specific process of Intra TMP-BV obtaining according to embodiments of this application includes three steps: determining a current template type, acquiring reconstructed pixels of a current template, and determining a block vector within a predefined search range. Corresponding to each acquired BV, a set of predicted values of the current coding block may be obtained. In some embodiments of this application, the search range may include a fully reconstructed search region and/or a to-be-determined reconstructed search region, where the fully reconstructed search region includes a reconstructed sample, and the to-be-determined reconstructed search region includes a reconstructed sample and/or an unreconstructed sample.

An embodiment of this application provides a decoding method. A decoder determines a first template corresponding to a current coding block, and determines a fully reconstructed search region and/or a to-be-determined reconstructed search region according to the first template, where the fully reconstructed search region includes a reconstructed sample, and the to-be-determined reconstructed search region includes a reconstructed sample and/or an unreconstructed sample. The decoder separately searches the fully reconstructed search region and/or the to-be-determined reconstructed search region and determines one or more block vectors of the current coding block. It can be learned that, in embodiments of this application, an Intra TMP-BV prediction manner is proposed, a to-be-determined reconstructed search region and/or a fully reconstructed search region are determined, availability determination of each search position is added to a traversing process of the to-be-determined reconstructed search region, so as to full utilizing information about all adjacent reconstructed samples. That is, the decoding method proposed in embodiments of this application fully considers, in a search process, importance of the to-be-determined reconstructed search region in which whether a sample point has been reconstructed is uncertain, to prediction of the current coding block, and available sample points in the to-be-determined reconstructed search region are fully used, so that prediction accuracy can be improved, and an optimal prediction effect can be obtained.

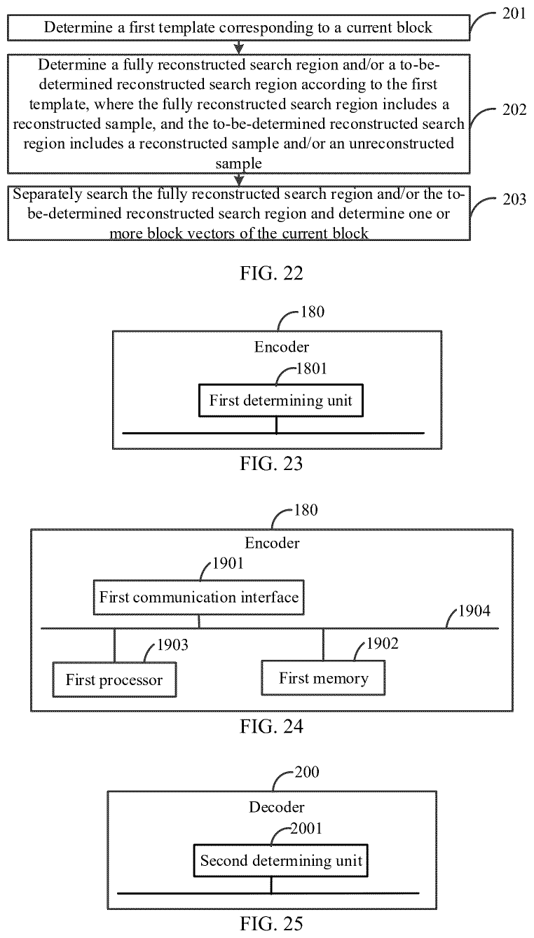

An embodiment of this application provides an encoding method. The encoding method is applied to an encoder. FIG. 22 is a schematic flowchart of an encoding method according to an embodiment of this application. As shown in FIG. 22, the method for performing an encoding process by an encoder may include the following steps.

Step 201: Determine a first template corresponding to a current coding block.

In some embodiments of this application, the first template corresponding to the current coding block may be first determined. When obtaining the first template, a template type corresponding to the current coding block may be first determined, and then the first template corresponding to the current coding block may be further determined according to the template type.

It should be noted that the encoding method in embodiments of this application is applied to an encoder. In addition, the encoding method may include an intra prediction method, and more specifically, a color component prediction method. The video image may be divided into multiple encoding blocks, and each encoding block may include a first color component, a second color component, and a third color component. In some embodiments of this application, the current coding block refers to a encoding block that is in the video image and that is currently to be used for performing intra prediction.

Herein, when the first color component is to be predicted, the to-be-predicted component is the first color component; when the second color component is to be predicted, the to-be-predicted component is the second color component; and when the third color component is to be predicted, the to-be-predicted component is the third color component. In addition, assuming that the current coding block is used to predict the first color component, and the first color component is a luma component, the to-be-predicted component is the luma component, and the current coding block may also be referred to as a luma block. Alternatively, assuming that the current coding block is used to predict a second color component, and the second color component is a chroma component, the to-be-predicted component is the chroma component, and the current coding block may also be referred to as a chroma block.

It should be further noted that in some embodiments of this application, the reference pixel (Reference Sample) of the current coding block may be a reference pixel adjacent to the current coding block. The “adjacent” herein may be adjacent in space, but is not limited thereto. For example, the “adjacent” may be “adjacent” in the time domain, or “adjacent” in space and in the time domain. Alternatively, a reference pixel of a current coding block may even be a reference pixel obtained by performing some processing on a pixel adjacent in space, or adjacent in the time domain, or adjacent in space and in the time domain, which is not limited in some embodiments of this application.

Further, in some embodiments of this application, the template type of the current coding block may be determined according to indication information in a bitstream. Alternatively, the template type of the current coding block may be determined according to the size of the current coding block.

Further, in some embodiments of this application, the template type of the current coding block may be determined according to a reference pixel of the current coding block. The reference pixel of the current coding block includes at least one of the following: a left adjacent reference pixel of the current coding block, an above adjacent reference pixel of the current coding block, an above left adjacent reference pixel of the current coding block, a below left adjacent reference pixel of the current coding block, or an above right adjacent reference pixel of the current coding block.

It may be understood that in some embodiments of this application, the reference pixel of the current coding block may include an adjacent reconstructed pixel of the current coding block, that is, adjacent reconstructed pixels of the current coding block may be used as a template to search for a matching template in a predefined search region.

It should be noted that in some embodiments of this application, the reference pixel of the current coding block, that is, the adjacent reconstructed pixel of the current coding block may include an above reference pixel, an above left reference pixel, an above right reference pixel, a left reference pixel, or a below left reference pixel of the current coding block.

It may be understood that, in some embodiments of this application, when determining the template type of the current coding block by using the reference pixel of the current coding block, the template type may be determined according to whether the adjacent reference pixel is available.

It may be understood that, in some embodiments of this application, after determining the template type of the current coding block, the template type may be indicated in a bitstream, so that the decoding side can determine the template type according to an indication in the bitstream.

Further, in some embodiments of this application, when determining the template type of the current coding block according to the reference pixel of the current coding block, if a left adjacent reference pixel of the current coding block, an above adjacent reference pixel of the current coding block, and an above left adjacent reference pixel of the current coding block are all available, the template type of the current coding block is determined as a first value; if a left adjacent reference pixel of the current coding block is available, the template type of the current coding block is determined as a second value; if an above adjacent reference pixel of the current coding block is available, the template type of the current coding block is determined as a third value; if a left adjacent reference pixel of the current coding block and an above left adjacent reference pixel of the current coding block are available, the template type of the current coding block is determined as a fourth value; if a left adjacent reference pixel of the current coding block and a below left adjacent reference pixel of the current coding block are available, the template type of the current coding block is determined as a fifth value; and if an above adjacent reference pixel of the current coding block and an above right adjacent reference pixel of the current coding block are available, the template type of the current coding block is determined as a sixth value.

It should be noted that, in some embodiments of this application, the first value, the second value, the third value, the fourth value, the fifth value, and the sixth value may be any values, which is not specifically limited in this application. For example, values of the first value, the second value, the third value, the fourth value, the fifth value, and the sixth value may be sequentially 1, 2, 3, 4, 5, and 6.

For example, in some embodiments of this application, refTemplateType may be used to represent a template type. Correspondingly, as shown in FIG. 3, the block that is filled with grids is a current coding block, and a region adjacent to the current coding block is a template T. Six template types are shown herein.

For example, the six template types are as follows. When the above left reference pixel, the above reference pixel, and the left reference pixel are all available, a value of refTemplateType is 1, and a template shape is as shown in (a) in FIG. 3. When only the left reference pixel is available, the value of refTemplateType is 2, and the template shape is as shown in (b) in FIG. 3. When only the above reference pixel is available, the value of refTemplate Type is 3, and the template shape is as shown in (c) in FIG. 3. When only the left reference pixel and the above left reference pixel are available, the value of refTemplateType is 4, and the template shape is as shown in (d) in FIG. 3. When only the left reference pixel and the below left reference pixel are available, the value of refTemplateType is 5, and the template shape is as shown in (e) in FIG. 3. When only the above reference pixel and the above right reference pixel are available, the value of refTemplateType is 6, and the template shape is as shown in (f) in FIG. 3.

In some embodiments, the foregoing reference pixel availability information may also be combined with an indication in the bitstream. For example, a sequence number of each template type is agreed, and the bitstream transmits a sequence number of an actually used template, so that the decoding side can determine the template type of the Intra TMP.

That is, in some embodiments of this application, the template type may be determined according to the availability information of the reference pixel of the current coding block, or the information for determining the template type may be indicated in the bitstream, or the template type may be determined with reference to the availability information of the reference pixel and the information indicated in the bitstream. This application sets no specific limitation.

Further, in some embodiments of this application, when determining the first template corresponding to the current coding block according to the template type, template reference pixels of the current coding block may be first determined according to the template type and a template size corresponding to the template type, and then the first template of the current coding block may be determined according to the template reference pixels.

It should be noted that in some embodiments of this application, the first template of the current coding block may include template reference pixels of the current coding block. The template reference pixels of the current coding block may be determined according to the template type of the current coding block and the template size corresponding to the template type.

It should be noted that in some embodiments of this application, the first template of the current coding block may be formed by reconstructed pixels in one or more of an above region, an above right region, a left region, a below left region, or an above left region of the current coding block, that is, may be formed by reference pixels of the current coding block.

It should be noted that in some embodiments of this application, a template size corresponding to the template type may be preset, may be indicated by a bitstream syntax element, or may be selected adaptively according to a block size or other information. For example, when the left template is obtained, the template width templateW_size may be set to 4, and when the above template is obtained, the template height templateH_size may be set to 4.

Correspondingly, in some embodiments of this application, with reference to a value of the template type refTemplateType of the current coding block and a template size corresponding to the refTemplate Type, a part of reconstructed pixels may be obtained as template reference pixels of the current coding block, and then a corresponding first template may be determined.

For example, in some embodiments of this application, when the value of refTemplate Type is 1, left, above left, and above reconstructed pixels of the current coding block may be selected. When the value of refTemplate Type is 2, only four columns of left reconstructed pixel of the current coding block are obtained. When the value of refTemplateType is 3, only four rows of above reconstructed pixels of the current coding block are obtained.

Certainly, a preset value of the template size may be any integer greater than 0, and is not limited to 4. This is not specifically limited in this application.

It may be understood that, in some embodiments of this application, with reference to the template type of the current coding block and the corresponding template size, the template reference pixels of the current coding block determined from the reference pixels of the current coding block may form the first template corresponding to the current coding block.

Step 202: Determine a fully reconstructed search region and/or a to-be-determined reconstructed search region according to the first template. The fully reconstructed search region includes a reconstructed sample, and the to-be-determined reconstructed search region includes a reconstructed sample and/or an unreconstructed sample.

Step 203: Separately search the fully reconstructed search region and/or the to-be-determined reconstructed search region and determine one or more block vectors of the current coding block.

For detailed description of Steps 202 and 203, reference can be made to the description of Steps 102 and 103.

Further, in some embodiments of this application, after the one or more reference blocks of the current coding block are determined according to the one or more block vectors, and the predicted value of the current coding block is determined according to the one or more reference blocks, a prediction residual (residual) may be determined according to the predicted value of the current coding block, and is written into a bitstream. Therefore, the decoder can determine the prediction residual corresponding to the current coding block by parsing the bitstream, and then determine the reconstructed value of the current coding block according to the prediction residual and the predicted value.

In conclusion, the proposed encoding method of step 201 to step 203 improves and optimizes a common Intra TMP technology. In the prediction process of the Intra TMP, a to-be-determined reconstructed search region and/or a fully reconstructed search region are determined, and availability determination of each search position is added to a traversing process of the to-be-determined reconstructed search region, thereby fully utilizing information about all adjacent reconstructed samples.

Inputs of the Intra TMP-BV obtaining are a location (xTbCmp, yTbCmp) of the current coding block (current coding block), a width nTbW of the current coding block, and a height nTbH of the current coding block. Outputs of the Intra TMP-BV obtaining are one or more BVs of the current coding block and corresponding prediction block predicted values of predSamples[x][y], where x=0 . . . nTbW−1, y=0 . . . nTbH−1. The prediction block predicted values may be used as a final predicted value, or may be further processed to obtain a final predicted value of the current coding block.

It may be understood that a specific process of Intra TMP-BV obtaining according to embodiments of this application includes three steps: determining a current template type, acquiring reconstructed pixels of a current template, and determining a block vector within a predefined search range. Corresponding to each acquired BV, a set of predicted values of the current coding block may be obtained. In some embodiments of this application, the search range may include a fully reconstructed search region and/or a to-be-determined reconstructed search region, where the fully reconstructed search region includes a reconstructed sample, and the to-be-determined reconstructed search region includes a reconstructed sample and/or an unreconstructed sample.

An embodiment of this application provides an encoding method. An encoder determines a first template corresponding to a current coding block, and determines a fully reconstructed search region and/or a to-be-determined reconstructed search region according to the first template, where the fully reconstructed search region includes a reconstructed sample, and the to-be-determined reconstructed search region includes a reconstructed sample and/or an unreconstructed sample. The decoder separately searches the fully reconstructed search region and/or the to-be-determined reconstructed search region and determines one or more block vectors of the current coding block. It can be learned that, in embodiments of this application, an Intra TMP-BV prediction manner is proposed, a to-be-determined reconstructed search region and/or a fully reconstructed search region are determined, availability determination of each search position is added to a traversing process of the to-be-determined reconstructed search region, so as to full utilizing information about all adjacent reconstructed samples. That is, the encoding and decoding methods proposed in embodiments of this application fully consider, in a search process, importance of the to-be-determined reconstructed search region in which whether a sample point has been reconstructed is uncertain, to prediction of the current coding block, and available sample points in the to-be-determined reconstructed search region are fully used, so that prediction accuracy can be improved, and an optimal prediction effect can be obtained.

In still another embodiment of this application, referring to FIG. 23, FIG. 23 shows a schematic structural diagram of an encoder according to an embodiment of this application. As shown in FIG. 23, the encoder 180 may include a first determining unit 1801.

The first determining unit 1801 is configured to determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

It may be understood that, in some embodiments of this application, the “unit” may be a part of a circuit, a part of a processor, a part of a program or software, or the like, or certainly may be a module, or may be not a module. In addition, each unit in this embodiment may be integrated into one processing unit, or each unit may exist separately physically, or two or more units may be integrated into one unit. The foregoing integrated unit may be implemented in a form of hardware, or may be implemented in a form of a software functional module.

If the integrated unit is implemented in a form of a software functional module and is not sold or used as an independent product, the integrated unit may be stored in a computer readable storage medium. Based on this understanding, the technical solution in this embodiment essentially, or the part contributing to the prior art, or all or a part of the technical solution may be implemented in a form of a software product. The computer software product is stored in a storage medium and includes several instructions for instructing a computer device (which may be a personal computer, a server, a network device, or the like) or a processor (processor) to perform all or a part of the steps of the method in this embodiment. The foregoing storage medium includes any medium that can store program codes, such as a USB flash drive, a removable hard disk, a read only memory (Read Only Memory, ROM), a random access memory (Random Access Memory, RAM), a magnetic disk, or an optical disc.

Therefore, an embodiment of this application provides a computer readable storage medium, which is applied to an encoder 180. The computer readable storage medium stores a computer program. When being executed by a first processor, the computer program implements the method in any one of the foregoing embodiments.

Based on a structure of the encoder 180 and a computer readable storage medium, referring to FIG. 24, FIG. 24 shows a specific schematic structural diagram of hardware of the encoder 180 according to an embodiment of this application. As shown in FIG. 24, the encoder 180 may include a first communications interface 1901, a first memory 1902, and a first processor 1903. The components are coupled together by a first bus system 1904. It may be understood that the first bus system 1904 is configured to implement connection and communication between these components. In addition to a data bus, the first bus system 1904 further includes a power bus, a control bus, and a status signal bus. However, for clear description, various buses in FIG. 17 are denoted as the first bus system 1904.

The first communications interface 1901 is configured to receive and send a signal in a process of transmitting and receiving information with another external network element.

The first memory 1902 is configured to store a computer program that can run on the first processor 1903.

The first processor 1903 is configured to: when running the computer program, determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

It may be understood that the first memory 1902 in some embodiments of this application may be a volatile memory or a non-volatile memory, or may include both a volatile memory and a non-volatile memory. The non-volatile memory may be a read-only memory (Read-Only Memory, ROM), a programmable ROM (Programmable ROM, PROM), an erasable PROM (Erasable PROM, EPROM), an electrically EPROM (Electrically EPROM, EEPROM), or a flash memory. The volatile memory may be a random access memory (RAM) that serves as an external cache. By way of example but not of limitation, many forms of RAM are available, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM) and direct rambus RAM (DRRAM). The first memory 1902 of the system and method described in this application is intended to include but is not limited to these and any other suitable type of memory.

The first processor 1903 may be an integrated circuit chip, and has a signal processing capability. In an implementation process, the steps of the foregoing methods may be completed by using an integrated logic circuit of hardware in the first processor 1903 or an instruction in a form of software. The foregoing first processor 1903 may be a general purpose processor, a digital signal processor (Digital Signal Processor, DSP), an application-specific integrated circuit (Application Specific Integrated Circuit, ASIC), a field programmable gate array (Field Programmable Gate Array, FPGA) or another programmable logic device, a discrete gate or transistor logic device, or a discrete hardware component. The methods, steps, and logical block diagrams disclosed in the embodiments of this application may be implemented or executed. The general-purpose processor may be a microprocessor, or the processor may be any conventional processor or the like. The steps of the methods disclosed with reference to the embodiments of this application may be directly executed by a hardware decoding processor, or executed by a combination of hardware and software modules in the decoding processor. The software module may be located in a mature storage medium in the art such as a random access memory, a flash memory, a read-only memory, a programmable read-only memory, or an electrically erasable programmable memory and a register. The storage medium is located in the first memory 1902. The first processor 1903 reads information in the first memory 1902, and completes the steps of the foregoing methods in combination with hardware of the first processor 1903.

It may be understood that the embodiments described in this application may be implemented by hardware, software, firmware, middleware, microcode, or a combination thereof. For hardware implementation, the processing unit may be implemented in one or more application specific integrated circuits (Application Specific Integrated Circuits, ASIC), a digital signal processor (Digital Signal Processing, DSP), a digital signal processing device (DSP Device, DSPD), a programmable logic device (Programmable Logic Device, PLD), a field programmable gate array (Field-Programmable Gate Array, FPGA), a general purpose processor, a controller, a microcontroller, a microprocessor, another electronic unit configured to perform the functions described in this application, or a combination thereof. For software implementation, the technology described in this application may be implemented by executing a module (for example, a process, a function, or the like) of the function described in this application. The software code may be stored in a memory and executed by a processor. The memory may be implemented in or outside the processor.

Optionally, in another embodiment, the first processor 1903 is further configured to: when running the computer program, execute the method in any one of the foregoing embodiments.

In still another embodiment of this application, referring to FIG. 25, FIG. 25 shows a schematic structural diagram of a decoder according to an embodiment of this application. As shown in FIG. 25, the decoder 200 may include a second determining unit 2001.

The second determining unit 2001 is configured to determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

It may be understood that, in some embodiments of this application, the “unit” may be a part of a circuit, a part of a processor, a part of a program or software, or the like, or certainly may be a module, or may be not a module. In addition, each unit in this embodiment may be integrated into one processing unit, or each unit may exist separately physically, or two or more units may be integrated into one unit. The foregoing integrated unit may be implemented in a form of hardware, or may be implemented in a form of a software functional module.

If the integrated unit is implemented in a form of a software function module block and is not sold or used as an independent product, the integrated unit may be stored in a computer readable storage medium. Based on such an understanding, this embodiment provides a computer readable storage medium, applied to a decoder 200, where the computer readable storage medium stores a computer program, and the computer program is executed by a second processor to implement the method in any one of the foregoing embodiments.

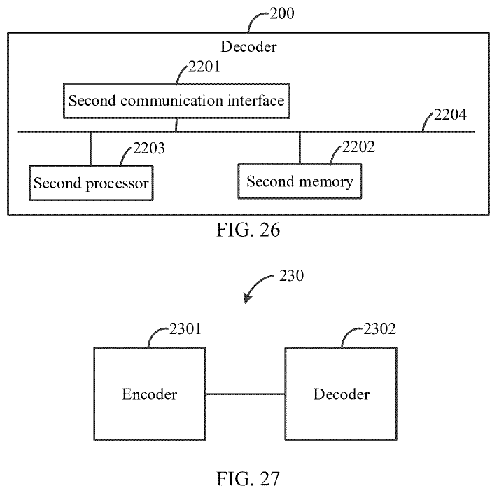

Based on a structure of the decoder 200 and a computer readable storage medium, referring to FIG. 26, FIG. 26 shows a schematic structural diagram of specific hardware of the decoder 200 according to an embodiment of this application. As shown in FIG. 26, the decoder 200 may include a second communications interface 2201, a second memory 2202, and a second processor 2203. The components are coupled together by a second bus system 2204. It may be understood that the second bus system 2204 is configured to implement connection and communication between these components. In addition to a data bus, the second bus system 2204 further includes a power bus, a control bus, and a status signal bus. However, for clear description, various buses are denoted as the second bus system 2204 in FIG. 19.

The second communications interface 2201 is configured to receive and send a signal in a process of transmitting and receiving information with another external network element.

The second memory 2202 is configured to store a computer program that can run on the second processor 2203.

The second processor 2203 is configured to: when running the computer program, determine a first template corresponding to a current coding block; determine a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately search the fully reconstructed search region and/or the to-be-determined reconstructed search region and determine one or more block vectors of the current coding block.

Optionally, in another embodiment, the second processor 2203 is further configured to: when running the computer program, execute the method in any one of the foregoing embodiments.

It may be understood that a hardware function of the second memory 2202 is similar to that of the first memory 1902, and a hardware function of the second processor 2203 is similar to that of the first processor 1903. Details are not described herein.

This embodiment provides an encoder and a decoder, which determines a first template corresponding to a current coding block; determines a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately searches the fully reconstructed search region and/or the to-be-determined reconstructed search region and determines one or more block vectors of the current coding block. It can be learned that, in embodiments of this application, an Intra TMP-BV prediction manner is proposed, a to-be-determined reconstructed search region and/or a fully reconstructed search region are determined, availability determination of each search position is added to a traversing process of the to-be-determined reconstructed search region, so as to full utilizing information about all adjacent reconstructed samples. That is, the encoding and decoding methods proposed in embodiments of this application fully consider, in a search process, importance of the to-be-determined reconstructed search region in which whether a sample point has been reconstructed is uncertain, to prediction of the current coding block, and available sample points in the to-be-determined reconstructed search region are fully used, so that prediction accuracy can be improved, and an optimal prediction effect can be obtained.

In still another embodiment of this application, referring to FIG. 20, FIG. 20 shows a schematic structural diagram of a coding system according to an embodiment of this application. As shown in FIG. 20, the coding system 230 may include an encoder 2301 and a decoder 2302.

In some embodiments of this application, the encoder 2301 may be the encoder in any one of the foregoing embodiments, and the decoder 2302 may be the decoder in any one of the foregoing embodiments.

Further, an embodiment of this application further provides a bitstream, where the bitstream is generated by performing bit encoding according to to-be-encode information; and the to-be-encode information includes at least one of following: a prediction residual of a current coding block, a preset quantity N, availability information of a reference pixel, a size of a template, or indication information of a template type.

It should be noted that in this application, the term “includes”, “comprises”, or any other variants is intended to cover non-exclusive inclusion, so that a process, method, article, or apparatus that includes a series of elements includes not only those elements but also other elements that are not explicitly listed, or includes elements inherent to such a process, method, article, or apparatus. In the absence of more restrictions, the statement “includes an element” does not excluding another same element in a process, method, article, or apparatus that includes the element.

The foregoing sequence numbers of the embodiments of this application are merely used for description, and do not represent preferences of the embodiments.

The methods disclosed in the several method embodiments provided in this application may be randomly combined without conflict to obtain new method embodiments.

The features disclosed in the several product embodiments provided in this application may be randomly combined without conflict to obtain a new product embodiment.

The features disclosed in the method embodiments and the device embodiments provided in this application may be randomly combined without conflict to obtain a new method embodiment or device embodiment.

The foregoing descriptions are merely some embodiments of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

### INDUSTRIAL PRACTICALITY

Embodiments of this application provide a decoding method, an encoding method, an encoder, a decoder, and a storage medium. The encoder and decoder determines a first template corresponding to a current coding block; determines a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and separately searches the fully reconstructed search region and/or the to-be-determined reconstructed search region and determines one or more block vectors of the current coding block. It can be learned that, in embodiments of this application, an Intra TMP-BV prediction manner is proposed, a to-be-determined reconstructed search region and/or a fully reconstructed search region are determined, availability determination of each search position is added to a traversing process of the to-be-determined reconstructed search region, so as to full utilizing information about all adjacent reconstructed samples. That is, the encoding and decoding methods proposed in embodiments of this application fully consider, in a search process, importance of the to-be-determined reconstructed search region in which whether a sample point has been reconstructed is uncertain, to prediction of the current coding block, and available sample points in the to-be-determined reconstructed search region are fully used, so that prediction accuracy can be improved, and an optimal prediction effect can be obtained.

What is claimed is:

1. A decoding method, applied to a decoder, wherein the method comprises:
determining a first template corresponding to a current coding block;
determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and
separately searching the fully reconstructed search region and/or the to-be-determined reconstructed search region and determining one or more block vectors of the current coding block.

2. The method according to claim 1, wherein the separately searching the fully reconstructed search region and/or the to-be-determined reconstructed search region to determine the one or more block vector of the current coding block comprises:
traversing search points in the fully reconstructed search region, and determining, according to a preset matching criterion, first matching cost values between the first template and matching templates corresponding to the search points in the fully reconstructed search region;
traversing search points in the to-be-determined reconstructed search region, and determining, according to the preset matching criterion, second matching cost values between the first template and matching templates corresponding to search points that meet a preset availability condition in the to-be-determined reconstructed search region; and
determining, according to the first matching cost values and the second matching cost values, the one or more block vectors and one or more candidate templates corresponding to the one or more block vectors.

3. The method according to claim 2, further comprising:
determining whether a current search point in the to-be-determined reconstructed search region meets the preset availability condition; and
if the current search point meets the preset availability condition, determining, according to the preset matching criterion, a second matching cost value between the first template and a matching template corresponding to the current search point.

4. The method according to claim 3, further comprising:
if the current search point does not meet the preset availability condition, skipping the determining of the second matching cost value.

5. The method according to claim 2, wherein the preset availability condition comprises at least one or more of following conditions:
none of samples in a matching template of a current search point exceeds a coordinate range of a sample boundary corresponding to a current image;
none of samples in a reconstruction block corresponding to a matching template of a current search point exceeds a coordinate range of a sample boundary corresponding to a current image;
none of samples in a matching template of a current search point exceeds a preset search window range;
none of samples in a reconstruction block corresponding to a matching template of a current search point exceeds a preset search window range;
all of samples in a matching template of a current search point are in a same tile as the current coding block;
all of samples in a reconstruction block corresponding to a matching template of a current search point are in a same tile as the current coding block;
all of samples in a matching template of a current search point have been reconstructed;
none of samples in a reconstruction block corresponding to a matching template of a current search point belongs to the current coding block; or
all of samples in a reconstruction block corresponding to a matching template of a current search point have been reconstructed.

6. The method according to claim 2, wherein the preset availability condition comprises at least one or more of following conditions:
none of first identification samples in a matching template of a current search point exceeds a coordinate range of a sample boundary corresponding to a current image;
none of second identification samples in a reconstruction block corresponding to a matching template of a current search point exceeds a coordinate range of a sample boundary corresponding to a current image;
none of first identification samples in a matching template of a current search point exceeds a preset search window range;
none of second identification samples in a reconstruction block corresponding to a matching template of a current search point exceeds a preset search window range;
all of first identification samples in a matching template of a current search point are in a same tile as the current coding block;
all of second identification samples in a reconstruction block corresponding to a matching template of a current search point are in a same tile as the current coding block;
all of first identification samples in a matching template of a current search point have been reconstructed;
none of second identification samples in a reconstruction block corresponding to a matching template of a current search point belongs to the current coding block; or
all of second identification samples in a reconstruction block corresponding to a matching template of a current search point have been reconstructed;
wherein the first identification samples are one or more samples in the matching template of the current search point; the second identification samples are one or more samples in the reconstruction block corresponding to the matching template of the current search point.

7. The method according to claim 2, further comprising:
determining a preset quantity N corresponding to the candidate templates, wherein N is an integer greater than 0; and
determining N block vectors and N candidate templates corresponding to the N block vectors according to the first matching cost values and the second matching cost values.

8. The method according to claim 7, further comprising:
determining N least matching cost values among the first matching cost values and the second matching cost values; and
determining, based on N search points corresponding to the N least matching cost values, the N block vectors and the N candidate templates corresponding to the N block vectors.

9. The method according to claim 7, further comprising:
separately searching the fully reconstructed search region and/or the to-be-determined reconstructed search region according to a first search step size, determining the first matching cost values corresponding to the search points in the fully reconstructed search region and the second matching cost values corresponding to the search points that meet the preset availability condition in the to-be-determined reconstructed search region, and determining, based on the first matching cost values and the second matching cost values, the N block vectors and the N candidate templates corresponding to the N block vectors; or
separately searching the fully reconstructed search region and/or the to-be-determined reconstructed search region according to a second search step size, determining the first matching cost values corresponding to the search points in the fully reconstructed search region and the second matching cost values corresponding to the search points that meet the preset availability condition in the to-be-determined reconstructed search region, and determining, based on the first matching cost values and the second matching cost values, the N block vectors and the N candidate templates corresponding to the N block vectors, wherein the first search step size is greater than the second search step sizes size.

10. The method according to claim 7, further comprising:
separately searching the fully reconstructed search region and/or the to-be-determined reconstructed search region according to a first search step size, determining the first matching cost values corresponding to the search points in the fully reconstructed search region and the second matching cost values corresponding to the search points that meet the preset availability condition in the to-be-determined reconstructed search region, and determining, based on the first matching cost values and the second matching cost values, M reference block vectors and M matching reconstruction blocks corresponding to the M reference block vectors, wherein M is an integer greater than 0;
determining a first search region according to the M matching reconstruction blocks, wherein the first search region is less than a total region formed by the fully reconstructed search region and/or the to-be-determined reconstructed search region;
searching the first search region according to a second search step size, to determine third matching cost values between the first template and matching templates corresponding to search points that meet the preset availability condition in the first search region, wherein the first search step size is greater than the second search step size; and
determining the N block vectors and the N candidate templates corresponding to the N block vectors according to the first matching cost values, the second matching cost values, and/or the third matching cost values.

11. The method according to claim 1, further comprising:
determining one or more reference blocks of the current coding block according to the one or more block vectors; and
determining a predicted value of the current coding block according to the one or more reference blocks.

12. The method according to claim 2, wherein
the preset matching criterion includes any one of: a sum of absolute difference (SAD), a sum of absolute transformed difference (SATD), a sum of squared error (SSE), a mean absolute difference (MAD), a mean absolute error (MAE), a mean square error (MSE), or a normalized correlation coefficient (NCC).

13. The method according to claim 11, wherein the determining the predicted value of the current coding block according to the one or more reference blocks comprises:
determining one or more weight values corresponding to the one or more reference blocks; and
performing weighted fusion processing on the one or more reference blocks according to the one or more weight values, to determine the predicted value of the current coding block.

14. The method according to claim 1, wherein the determining the first template corresponding to current coding block comprises:
determining a template type corresponding to the current coding block, and determining the first template corresponding to the current coding block according to the template type.

15. The method according to claim 14, wherein the determining the template type corresponding to the current coding block comprises:
determining the template type of the current coding block according to a reference pixel of the current coding block; or
determining the template type of the current coding block according to indication information in a bitstream; or
determining the template type of the current coding block according to a size of the current coding block; wherein the reference pixel of the current coding block comprises at least one of the following: a left adjacent reference pixel of the current coding block, an above adjacent reference pixel of the current coding block, an above left adjacent reference pixel of the current coding block, a below left adjacent reference pixel of the current coding block, or an above right adjacent reference pixel of the current coding block.

16. An encoding method, applied to an encoder, wherein the method comprises:
determining a first template corresponding to a current coding block;
determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and
separately searching the fully reconstructed search region and/or the to-be-determined reconstructed search region and determining one or more block vectors of the current coding block.

17. An encoder, comprising a first memory and a first processor, wherein
the first memory is configured to store a computer program runnable on the first processor; and
the first processor is configured to perform the method according to claim 16 when running the computer program.

18. A decoder, wherein the decoder comprises a second memory and a second processor, wherein
the second memory is configured to store a computer program runnable on the second processor; and
the second processor is configured to perform the method according to claim 1 when running the computer program.

19. A non-transitory computer readable storage medium, wherein the computer readable storage medium stores a computer program, and when the computer program is executed, a decoding method is implemented, comprising:
determining a first template corresponding to a current coding block;
determining a fully reconstructed search region and/or a to-be-determined reconstructed search region according to the first template, wherein the fully reconstructed search region comprises a reconstructed sample, and the to-be-determined reconstructed search region comprises a reconstructed sample and/or an unreconstructed sample; and
separately searching the fully reconstructed search region and/or the to-be-determined reconstructed search region and determining one or more block vectors of the current coding block.

20. A non-transitory computer readable storage medium, wherein the computer readable storage medium stores a computer program, and when the computer program is executed, the encoding method according to claim 16 is implemented.
